(19) United States
(12) Patent Application Publication
(10) Pub. No.: US 2026/0332278 A1
(43) Pub. Date: Oct. 22, 2026

(54) SYSTEM

(71) Applicant: SoftBank Group Corp., Tokyo (JP)

(72) Inventor: Yuta MIKI, Tokyo (JP)

(73) Assignee: SoftBank Group Corp., Tokyo (JP)

(21) Appl. No.: 19/646,584

(22) Filed: Apr. 14, 2026

(30) Foreign Application Priority Data
Apr. 22, 2025 (JP) 2025-070615

(51) Int. Cl. H04B 17/391; G06F 16/387; G06T 19/00

(52) U.S. Cl. CPC H04B 17/3912; G06F 16/387; G06T 19/006; H04B 17/3913

(57) ABSTRACT

A system includes circuitry configured to receive terrain attribute, population density, and radio propagation data for geographic grid cells via a network and store the data in a storage device. The circuitry constructs a hierarchical grid data structure using a space division algorithm that assigns identifiers and refines high-density cells, and manages grid attributes in a distributed database. A generative neural network, including a graph neural network inference engine, is applied by modeling grid cells as nodes with adjacency edges, performing message passing, and generating latent representations and suitability scores. Grid cells are clustered based on suitability to identify candidate installation areas, and candidate site records with coordinates, suitability parameters, and coverage projections are generated and transmitted with three-dimensional visualization data to terminal devices.

### CROSS-REFERENCE TO RELATED APPLICATION

The present application claims priority to and incorporates by reference the entire contents of Japanese Patent Application No. 2025-070615 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is that, when selecting an installation site for a radio base station, although it is necessary to comprehensively and objectively evaluate a plurality of different elements such as terrain, population density, and radio wave propagation characteristics, conventionally, it has been necessary to individually collect and analyze these pieces of information and perform a manual comparative examination on spreadsheet software or a map, and therefore, an enormous amount of time and effort, as well as specialized knowledge and experience, are required, making it difficult to improve the efficiency and optimize an installation plan, resulting in problems such as subjective judgment and oversight in selecting the installation site, an increase in cost, and non-uniformity of communication quality after installation. Furthermore, in the conventional method of examining an installation candidate site, it is limited to an abstract comparison using only a map and numerical data, and it has been difficult to intuitively grasp the terrain and surrounding environment of the site, the distribution of communication demand, the ease of radio wave propagation, and the like, so there is also a problem that speeding up of decision-making and sophistication of the installation plan have not been sufficiently realized. Therefore, an object of the present invention is to integrally analyze various types of information such as terrain data, population density data, and radio wave propagation characteristic data using generative AI, automatically extract an optimal installation candidate site, and utilize a three-dimensional visualization function by AR or VR to provide an environment in which a person in charge can intuitively and efficiently compare and examine installation sites, thereby simultaneously realizing efficiency improvement of the radio base station installation plan, cost reduction, uniformization of communication quality, speeding up of decision-making, and elimination of subjective judgment.

### SUMMARY OF THE INVENTION

A means for solving the problem according to the present invention is to configure a system comprising a terrain data acquisition unit, a population density data acquisition unit, a radio wave propagation characteristic data acquisition unit, a generative AI processing unit, a candidate site selection unit, an AR visualization unit, and a VR visualization unit. Specifically, the terrain data acquisition unit acquires terrain information such as an elevation and an inclination from a geographic information system, an external database, or the like, the population density data acquisition unit acquires population density information for each point from statistical data, sensor data, or the like, and the radio wave propagation characteristic data acquisition unit acquires information regarding radio wave attenuation and propagation characteristics at each point from simulation data, an actual measurement value, or the like. These acquired data are input to the generative AI processing unit, and the generative AI processing unit normalizes the terrain data, the population density data, and the radio wave propagation characteristic data, respectively, weights each element, and calculates a total score. The candidate site selection unit automatically extracts a candidate site suitable for installing a radio base station based on the total score calculated by the generative AI processing unit. Furthermore, the AR visualization unit and the VR visualization unit intuitively and visually display information such as coordinates, an elevation, a population density, a radio wave propagation characteristic, and a total score of the installation candidate site extracted by the candidate site selection unit in a three-dimensional space, thereby enabling a person in charge to easily compare and examine a site situation and various elements, eliminating a conventional complicated manual comparison and subjective judgment, which is a means for realizing efficiency improvement and optimization of the radio base station installation plan.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

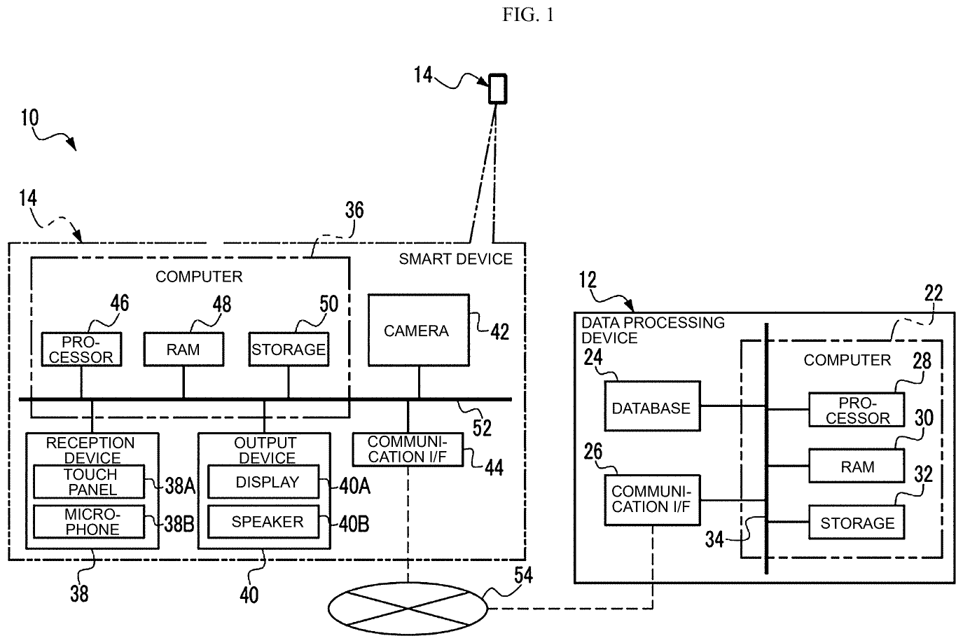

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

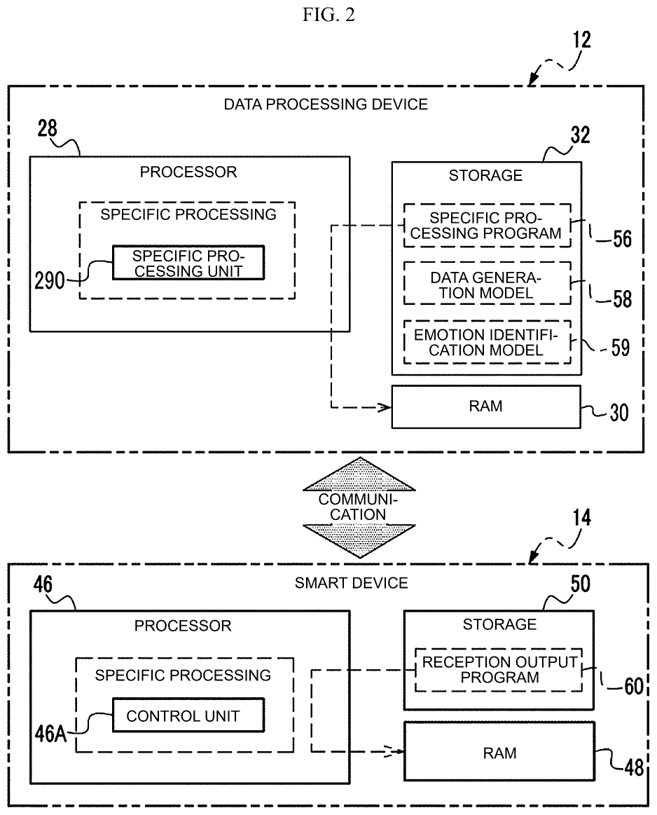

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

Embodiments for carrying out the present invention will be described more specifically and in detail. The system of the present invention is realized by a cooperative operation of a server and a terminal. A terrain data acquisition unit, a population density data acquisition unit, a radio wave propagation characteristic data acquisition unit, a generative AI processing unit, and a candidate site selection unit are mounted on the server side, and an AR visualization unit and a VR visualization unit are mounted on the terminal side. Hereinafter, the configuration, function, processing flow of each unit, a method of utilizing generative AI, role sharing between the server and the terminal, specific usage examples, expansion examples, and the like will be comprehensively and multilaterally described. Specifically, the present system adopts a distributed computing architecture. The present system connects a parallel computing cluster using a GPU on the server side and an edge processor on the terminal side via a broadband network. The present system executes a large-scale tensor operation on the server side. The present system executes a low-latency rendering process on the terminal side. The present system thereby optimally distributes a calculation load. The present system arranges a plurality of data acquisition modules on the server side. The present system containerizes each module as an independent microservice. The present system thereby improves scalability. The present system mounts a transformer-based large language model and a graph neural network as the generative AI processing unit. The present system includes an arithmetic circuit configured to execute a heuristic search algorithm as the candidate site selection unit. The present system is equipped with a depth sensor and an inertial measurement unit for spatial recognition on the terminal side. The present system executes a real-time three-dimensional coordinate conversion process in the AR visualization unit and the VR visualization unit. The present system completely eliminates a conventional manual map confirmation work by a human through the cooperation of these hardware and software. The present system calculates an installation location of a radio base station as an optimization problem in a high-dimensional data space. The present system thereby dramatically improves the speed of a selection process. The present system simultaneously reduces an error in selection accuracy. The present system is used for a high-density deployment plan of a millimeter-wave band base station of a next-generation communication standard to an urban area as a specific application field. The present system is also applied to a rapid arrangement determination of a temporary base station at the time of disaster recovery.

First, the terrain data acquisition unit operates on the server and acquires terrain data from various information sources such as a geographic information system, an external map database, a satellite image provision service, drone aerial photography data, and public data of a local government. For example, elevation mesh data can be acquired at different resolutions such as 1-meter units, 5-meter units, and 10-meter units, and can be selectively used according to accuracy requirements of an installation candidate site. Furthermore, inclination angle data, land use classification data (residential area, commercial area, industrial area, agricultural land, forest, river, etc.), ground strength data, soil classification data, flood and sediment disaster risk data, and the like can also be acquired. For example, a process of automatically excluding an area with soft ground or an area with a past disaster history can also be incorporated. Specifically, the present terrain data acquisition unit executes asynchronous communication with a plurality of external API endpoints. The present terrain data acquisition unit converts the acquired spatial data in heterogeneous formats into a common three-dimensional voxel grid format. The present terrain data acquisition unit expands the elevation mesh data on a memory as a two-dimensional floating-point array. The present terrain data acquisition unit dynamically downsamples or upsamples the resolution of the array according to the size of a target area. The present terrain data acquisition unit automatically calculates the inclination angle data by a spatial differential operation of the elevation array. The present terrain data acquisition unit one-hot encodes the land use classification data as a categorical variable. The present terrain data acquisition unit assigns the ground strength data and the disaster risk data as an attribute vector for each voxel. The present terrain data acquisition unit constructs these preprocessed data as a multidimensional tensor. The present terrain data acquisition unit outputs the constructed tensor to the subsequent generative AI processing unit. The present terrain data acquisition unit includes a rule-based filtering circuit. The present terrain data acquisition unit applies a mask process to a voxel whose ground strength is less than a predetermined threshold. The present terrain data acquisition unit sets a calculation weight of a coordinate region where a disaster history flag is valid to zero. The present terrain data acquisition unit suppresses consumption of useless calculation resources during subsequent AI inference by this mask process. The present terrain data acquisition unit thereby improves the processing speed of the entire system. The present terrain data acquisition unit is used for a construction feasibility study of a steel tower type base station in a mountainous area as a specific application field. The present terrain data acquisition unit is also applied to a safe communication infrastructure design avoiding a flood risk area along a river.

The population density data acquisition unit operates on the server and acquires various types of population and human flow data such as census data, basic resident register data of a local government, base station connection logs of mobile terminals, traffic flow sensor data, SNS post location information, Wi-Fi access point connection count data, commercial facility visitor count data, and event organizer visitor count data. For example, it is possible to grasp fluctuations in population density for each time zone or situation, such as weekdays/holidays, day/night, seasons, and during events, and reflect them in the evaluation of the installation candidate site. Furthermore, it is also possible to acquire population prediction data of future urban development plans and redevelopment areas, enabling an installation plan anticipating future demand. Specifically, the present population density data acquisition unit mounts a stream data processing engine. The present population density data acquisition unit accumulates base station connection logs and sensor data flowing in real time in a time-series database. The present population density data acquisition unit aggregates the acquired raw data for each time frame. The present population density data acquisition unit structures the aggregation result as a time-series vector for each spatial mesh. The present population density data acquisition unit generates, for example, a 24-dimensional numerical vector indicating population fluctuations every hour. The present population density data acquisition unit applies a natural language processing model to the SNS post location information. The present population density data acquisition unit determines the presence or absence of an event occurrence from the post content. The present population density data acquisition unit combines this determination result as a binary flag with the time-series vector. The present population density data acquisition unit executes a linear interpolation process on future population prediction data. The present population density data acquisition unit holds the interpolated predicted value in a memory as a future demand tensor. The present population density data acquisition unit inputs these time-series vectors and the future demand tensor to a recurrent neural network. The present population density data acquisition unit predicts a communication traffic demand score of each spatial mesh using this network. The present population density data acquisition unit fundamentally improves a conventional evaluation method based on mere static population statistics by this prediction process. The present population density data acquisition unit enables dynamic and predictive demand evaluation. The present population density data acquisition unit thereby prevents overinvestment in base stations. The present population density data acquisition unit is used for a response plan to a temporary traffic surge around a large-scale stadium as a specific application field. The present population density data acquisition unit is also applied to a phased base station expansion simulation accompanying a new town development.

The radio wave propagation characteristic data acquisition unit operates on the server and acquires three-dimensional map data, building/tree/terrain obstacle data, communication quality logs of existing base stations, output data of a radio wave propagation simulation tool, weather data (rainfall, snowfall, wind direction and speed, temperature, humidity, etc.), moving object obstacle data such as vehicles and railways, and the like. For example, a radio wave propagation simulation considering the height and density of buildings and trees is executed on a three-dimensional map, and a radio wave attenuation rate, a propagation loss, an influence of a shielding object, an occurrence probability of multipath and fading, and the like for each point are calculated. Furthermore, fluctuations in propagation characteristics due to weather conditions (for example, an increase in attenuation during rainfall, reflection and absorption due to snowfall, shielding fluctuations due to swaying of trees caused by strong winds, etc.) can also be considered. As actual measurement values of existing base stations, communication speed, connection stability, disconnection rate, the number of complaints from users, and the like are also acquired, enabling an evaluation reflecting the actual situation on site. Specifically, the present radio wave propagation characteristic data acquisition unit includes a dedicated arithmetic processor configured to execute a ray tracing algorithm. The present radio wave propagation characteristic data acquisition unit constructs the three-dimensional map data and the obstacle data as a polygon mesh in a virtual space. The present radio wave propagation characteristic data acquisition unit calculates a virtual radio wave radiation path in this virtual space. The present radio wave propagation characteristic data acquisition unit calculates a reflection coefficient and a diffraction coefficient in each path based on a material attribute. The present radio wave propagation characteristic data acquisition unit derives a received power intensity in each voxel in the space as a floating-point number from this calculation result. The present radio wave propagation characteristic data acquisition unit inputs the weather data as an environmental parameter to a simulation model. The present radio wave propagation characteristic data acquisition unit dynamically adds an attenuation coefficient according to a rainfall amount. The present radio wave propagation characteristic data acquisition unit uses the communication quality logs of the existing base stations as training data. The present radio wave propagation characteristic data acquisition unit optimizes parameters of a propagation model by a gradient descent method so as to minimize an error between a simulation result and an actual measurement value. The present radio wave propagation characteristic data acquisition unit continuously improves the accuracy of the simulation by this optimization process. The present radio wave propagation characteristic data acquisition unit formats the calculated radio wave attenuation rate and multipath occurrence probability as a multidimensional feature vector. The present radio wave propagation characteristic data acquisition unit supplies this feature vector to a subsequent AI model. The present radio wave propagation characteristic data acquisition unit eliminates a risk of deterioration in communication quality after installation in advance by this highly accurate propagation prediction. The present radio wave propagation characteristic data acquisition unit thereby dramatically increases the reliability of a communication network. The present radio wave propagation characteristic data acquisition unit is used for a utilization plan of complex reflected waves in a millimeter-wave band in an urban area where high-rise buildings are densely packed as a specific application field. The present radio wave propagation characteristic data acquisition unit is also applied to a prediction of communication coverage fluctuations during snowfall in a heavy snowfall area.

These various types of data are input to the generative AI processing unit on the server. The generative AI processing unit is configured by combining, for example, a large language model, a deep learning model, an image generation AI, a time-series analysis AI, a multimodal AI, and the like. The generative AI normalizes the terrain data, the population density data, and the radio wave propagation characteristic data, respectively, and sets an evaluation criterion for each element, for example, by subtracting a normalized value of the terrain data from 1 when a lower elevation is more suitable for installation, using a normalized value of the population density data as it is when a higher population density is expected to have a communication demand, and subtracting a normalized value of the radio wave propagation characteristic data from 1 when less radio wave attenuation results in a higher evaluation. Furthermore, the generative AI performs weighting on these elements, and can dynamically adjust the weight according to an application or an operation policy, such as a population density-oriented type, a terrain stability-oriented type, and a radio wave quality-oriented type. The generative AI can also incorporate past installation records, communication quality data, feedback from on-site personnel, and the like as learning data, and continuously improve extraction accuracy of the installation candidate site. For example, from operation records of base stations installed in the past, communication quality and a trouble occurrence rate after installation can be learned and reflected in the extraction of the installation candidate site under similar conditions. In addition, the generative AI can automatically generate an optimal evaluation logic according to a plurality of installation purposes (for example, coverage expansion in an urban area, elimination of a blind spot in a mountainous area, temporary expansion at an event venue, etc.). Specifically, the present generative AI processing unit mounts a multimodal neural network based on a transformer architecture. The present generative AI processing unit receives a three-dimensional tensor indicating the terrain data, a time-series vector indicating the population density data, and a feature vector indicating the radio wave propagation characteristic data as input data. The present generative AI processing unit inputs these input data to respective dedicated encoder layers. The present generative AI processing unit combines latent representation vectors output from the respective encoder layers. The present generative AI processing unit applies a self-attention mechanism to this combined vector. The present generative AI processing unit extracts a complex nonlinear relationship such as an interaction between terrain and radio wave propagation by this self-attention mechanism. The present generative AI processing unit receives, for example, a group of numerical values such as “an inclined land with an elevation of 50 meters”, “a population influx of 1000 people per hour”, and “a radio wave attenuation rate of 20 percent during rainfall” as input data. The present generative AI processing unit scales these numerical values to a range from zero to one in a normalization layer. The present generative AI processing unit outputs an installation suitability score for each spatial coordinate as a floating-point number from zero to one hundred as output data. The present generative AI processing unit also outputs an importance map indicating a basis for the score as an image tensor in a heat map format. The present generative AI processing unit further outputs a recommendation reason text in natural language. The present generative AI processing unit generates, for example, a text saying “Since this point has a high population density and less shielding by buildings, a reach range of a millimeter wave is maximized.” The present generative AI processing unit transmits this output result to the subsequent candidate site selection unit. The present generative AI processing unit uses past installation record data as a correct label in a learning phase. The present generative AI processing unit calculates a mean square error between a predicted score and an actual communication quality index as a loss function. The present generative AI processing unit updates a weight parameter of the network using an error backpropagation method. The present generative AI processing unit establishes a data-driven evaluation criterion that does not depend on human intuition by this learning process. The present generative AI processing unit thereby ensures objectivity and reproducibility of evaluation. The present generative AI processing unit is used for complete automation of a base station installation plan of thousands of stations per year in a nationwide communication carrier as a specific application field. The present generative AI processing unit is also applied to generation of an optimal arrangement route of a mobile base station vehicle tailored to a specific event.

The total score calculated by the generative AI processing unit is sent to the candidate site selection unit on the server, and the candidate site selection unit flexibly extracts an installation candidate site according to an operation policy, such as the top 10 points in score or all points exceeding a predetermined threshold. For the extracted candidate site, detailed data such as coordinates, an elevation, a population density, a radio wave propagation characteristic, a total score, and surrounding environment information of each point are organized and transmitted to the terminal side. Specifically, the present candidate site selection unit includes an arithmetic module configured to execute a sorting algorithm and a clustering algorithm. The present candidate site selection unit receives a total score array for each of tens of thousands of spatial coordinates output from the generative AI processing unit. The present candidate site selection unit quick-sorts this score array in descending order. The present candidate site selection unit executes a spatial clustering process in order to prevent top points from being geographically too close to each other. The present candidate site selection unit selects only one representative point with the highest score in each cluster. The present candidate site selection unit minimizes duplication of a cover area of a base station by this spatial filtering. The present candidate site selection unit generates a structured data object in a JSON format for each extracted candidate site. The present candidate site selection unit stores floating-point data of latitude and longitude, integer data of an elevation, a time-series array of a population density, a vector for a radar chart of a radio wave propagation characteristic, and a total score in this object. The present candidate site selection unit transmits this structured data to the terminal side via an encrypted communication protocol. The present candidate site selection unit eliminates a work in which a human visually narrows down candidates from a huge list by this automatic extraction process. The present candidate site selection unit thereby dramatically shortens the time required for a selection process from several weeks to several seconds. The present candidate site selection unit is used for an efficient arrangement determination of a base station for a rural area in a vast rural region as a specific application field. The present candidate site selection unit is also applied to an optimal arrangement plan of a gateway for an IoT sensor in a smart city project.

The AR visualization unit and the VR visualization unit are mounted on the terminal side. For example, when on-site personnel visit a site using a tablet terminal, a position, a recommendation degree, and various scores of an installation candidate site can be superimposed and displayed on a camera image of the terminal. For example, the AR visualization unit displays the position of the installation candidate site with a pin or a three-dimensional icon on an actual landscape of the site, and when each candidate site is tapped, detailed information such as an elevation, a population density, a radio wave propagation characteristic, and a total score is pop-up displayed. Furthermore, a plurality of candidate sites can be simultaneously compared and displayed, and an optimal installation location can be intuitively selected. The VR visualization unit superimposes and displays a terrain model, a building model, a population distribution heat map, a radio wave propagation simulation result, and the like in a three-dimensional virtual space using, for example, a goggle-type terminal, and the personnel can multilaterally confirm a surrounding environment, a communication demand, and a radio wave quality of each candidate site while freely moving in the virtual space. For example, special circumstances for each site, such as a state of radio wave shielding in a group of high-rise buildings in an urban area, a blind spot of radio waves in a valley in a mountainous area, and a temporary population concentration around an event venue, can also be visualized three-dimensionally. Specifically, the present AR visualization unit processes an RGB image tensor acquired from a camera of the terminal and point cloud data acquired from a depth sensor in real time. The present AR visualization unit executes a simultaneous localization and mapping algorithm. The present AR visualization unit calculates absolute coordinates and a posture angle of the terminal in a three-dimensional space with high accuracy by this algorithm. The present AR visualization unit converts latitude and longitude coordinates of the candidate site received from the server into a local coordinate system of the terminal. The present AR visualization unit renders a three-dimensional polygon object at a corresponding pixel position of the camera image based on the converted coordinates. The present AR visualization unit detects a tap operation of a user as a two-dimensional vector of screen coordinates. The present AR visualization unit performs a raycast determination between this vector and the three-dimensional object. The present AR visualization unit overlay-displays a text layer of detailed information when the determination is true. The present VR visualization unit draws a high-resolution three-dimensional virtual space using a graphics processing unit. The present VR visualization unit maps a radio wave propagation simulation result as color information for each voxel. The present VR visualization unit draws the strength of a radio wave translucently in the space as a gradation color from red to blue. The present VR visualization unit detects a movement of a user's head with a gyro sensor. The present VR visualization unit updates a viewpoint of a virtual camera at a rate of 90 frames per second or more based on this detection data. The present system allows intuitive understanding of a spatial spread of radio waves and an influence of a physical obstacle, which cannot be grasped on a two-dimensional map, by these advanced rendering technologies. The present system thereby dramatically improves the accuracy of decision-making on site. The present system is used for an installation location examination of an indoor antenna in an underground mall or a large shopping mall, which is a complex indoor environment, as a specific application field. The present system is also applied to a remote cooperative work in which an expert in a remote location shares a VR space and gives an instruction to an on-site worker.

In addition, on-site personnel can upload additional information, site photographs, on-site observation data, and the like from the terminal side to the generative AI processing unit on the server side, and the generative AI can analyze and learn these new data in real time, and immediately update an evaluation and an extraction result of an installation candidate site. For example, the generative AI can flexibly incorporate site-specific information that cannot be grasped only by conventional statistical data, such as an obstacle newly discovered on site, a population fluctuation due to a season, and a sudden event holding, and reflect it in an installation plan. Specifically, the present system mounts an on-site information collection module on the terminal side. The present on-site information collection module acquires high-resolution image data captured by a camera of the terminal as a byte array in a JPEG format. The present on-site information collection module simultaneously adds position information and a time stamp acquired from a GPS module to an image as metadata. The present on-site information collection module transmits this image file with metadata to the server via a RESTful API. The generative AI processing unit on the server side receives this image file. The present generative AI processing unit inputs the image data to a convolutional neural network. The present generative AI processing unit specifies a building under construction or a grown tree, which is a new obstacle in the image, by an object detection algorithm using this network. The present generative AI processing unit outputs bounding box coordinates and a class label of the detected object. The present generative AI processing unit dynamically updates a corresponding voxel of three-dimensional map data on the server based on this output result. The present generative AI processing unit re-executes a radio wave propagation simulation using the updated map data. The present generative AI processing unit recalculates a total score using this recalculated radio wave attenuation rate as a new feature. The present generative AI processing unit immediately push-notifies a new candidate site list based on this recalculated score to the terminal. The present system eliminates an information discrepancy between a static database and a dynamic real world by this real-time feedback loop. The present system thereby always maintains an optimal installation plan based on the latest on-site situation. The present system is used for agile network construction following daily environmental changes in a rapidly developing new residential area as a specific application field. The present system is also applied to an emergency response system that immediately incorporates a terrain change immediately after a disaster occurrence from a drone image and establishes an optimal temporary communication route.

As described above, in the embodiment of the present invention, large-scale data collection, analysis, and AI processing are intensively performed on the server side, and intuitive and interactive visualization and comparative examination are realized on the terminal side, whereby an installation location selection of a radio base station can be efficiently and highly optimized. The generative AI plays an indispensable role in that it not only performs mere data analysis but also learns various elements such as past installation records, on-site information, and differences in operation purposes, and automatically generates and optimizes an installation candidate site extraction logic. For example, it is possible to automatically switch evaluation criteria between an urban area and a mountainous area, immediately reflect feedback from on-site personnel, and continuously learn operation records after installation to improve accuracy. Furthermore, the AR/VR visualization function on the terminal side enables three-dimensional and intuitive comparative examination, which has been difficult with conventional maps and spreadsheet software, and can simultaneously realize efficiency improvement of an installation plan, cost reduction, uniformization of communication quality, and speeding up of decision-making. Specifically, the present system constructs a hybrid processing architecture in which a cloud computing environment and an edge device are tightly coupled. The present system executes inference of a deep learning model on a scale of hundreds of millions of parameters at high speed using a tensor processing unit on the server side. The present system executes three-dimensional rendering of millions of polygons per second using a mobile GPU on the terminal side. The present system provides a user with interactive operability without delay while minimizing consumption of a network bandwidth by this role sharing. The present generative AI processing unit mounts a reinforcement learning algorithm. The present generative AI processing unit defines a communication quality index after installation as a reward function. The present generative AI processing unit autonomously adjusts a hyperparameter of an extraction logic so as to maximize this reward. The present generative AI processing unit completely substitutes a manual parameter tuning work by a human engineer by this autonomous learning mechanism. The present system maximizes utilization efficiency of calculation resources by this technical configuration. The present system simultaneously mathematically solves a complex multi-objective optimization problem as a gradient search in a multidimensional space. The present system thereby sublimates a selection work that has conventionally depended on a heuristic rule of thumb into a completely data-driven and reproducible engineering process. The present system is used when a globally expanding communication carrier constructs a standardized base station deployment platform adapted to different geographical conditions and laws and regulations of countries around the world as a specific application field. The present system is also applied to a large-scale project of optimally arranging a low-latency communication infrastructure for an autonomous driving vehicle along a nationwide road network.

Furthermore, for example, in selecting an installation candidate site, the generative AI can automatically propose an installation plan in which communication is less likely to be disrupted even during a disaster, in consideration of an evacuation route and location information of an evacuation shelter during a disaster, a passage route of an emergency vehicle, a location of an important infrastructure facility, and the like. Alternatively, by incorporating a future demographic prediction, an urban development plan, a new construction plan of a traffic infrastructure, and the like, long-term installation optimization looking several years ahead is also possible. Furthermore, an installation cost, a maintenance and management cost, a power supply status, land owner information, laws and regulations/ordinance information, and the like can also be incorporated as data, and an installation candidate site can be extracted while performing a comprehensive cost/risk evaluation. Specifically, the present system connects to an external disaster prevention information database and an urban planning database via a dedicated API gateway. The present system acquires position coordinates of an evacuation shelter and route information of an emergency vehicle as graph structure data. The present system inputs this graph data to a graph neural network. The present system specifies an important node on a network topology using this network. The present system assigns a new feature vector called a disaster importance score to a spatial mesh around this important node. The present system also acquires land price data, unit price data of construction work, and lead-in distance data of a commercial power supply of each candidate site as a numerical matrix. The present system calculates an initial investment cost and a running cost of each candidate site using this matrix. The present system executes a multi-objective optimization algorithm having conflicting objective functions of maximizing communication quality and minimizing a total cost in the generative AI processing unit. The present generative AI processing unit calculates a plurality of optimal solutions on a Pareto boundary. The present generative AI processing unit outputs this calculation result as a plurality of installation plans. The present generative AI processing unit generates results based on different parameter sets, for example, a “cost-oriented plan”, a “disaster resistance-oriented plan”, and a “future expandability-oriented plan”. The present system automates planning of a comprehensive infrastructure investment plan beyond a mere technical radio wave simulation on a computer by this multilateral evaluation process. The present system thereby strongly supports decision-making by management. The present system is used for a robust communication infrastructure design of a smart city constructed in collaboration between a local government and a communication carrier as a specific application field. The present system is also applied to an optimal universal service provision plan within a limited budget in a depopulated area.

Also, for example, when a plurality of telecommunications carriers jointly install a base station, the generative AI can consider the communication method and frequency band of each carrier, the risk of interference with existing equipment, interoperability, and the like, and automatically generate an optimal shared installation plan. Furthermore, even in the operation stage after installation, the generative AI can continuously learn communication quality logs and feedback from users, and automatically perform re-evaluation of the installation site, additional installation, removal proposals, and the like as necessary. Specifically, the present system adopts a multi-tenant data management architecture. The present system stores frequency allocation information, an antenna directivity pattern, and a transmission power setting of each telecommunications carrier as individual profile data in a secure database. The generative AI processing unit reads this profile data. The generative AI processing unit simulates intermodulation distortion and adjacent channel interference between different frequency bands at a physical layer level. The generative AI processing unit incorporates this interference simulation result into a comprehensive evaluation function as a penalty score. The generative AI processing unit searches for an optimal combination of height and angle when arranging antennas of a plurality of carriers on the same steel tower using a genetic algorithm so as to minimize this function. In the operation stage, the present system accumulates performance indicators such as throughput, delay, and packet loss rate periodically transmitted from each base station in a time-series database. The generative AI processing unit applies an anomaly detection algorithm to this time-series data. When detecting a constant downward trend in communication quality, the generative AI processing unit outputs an alert signal recommending additional base station installation for the area. Through this continuous monitoring and re-evaluation loop, the present system realizes autonomous optimization over the entire life cycle of the network. The present system thereby significantly reduces maintenance and operation costs. As a specific application field, the present system is used for a business in which an infrastructure sharing operator presents an optimal steel tower rental plan to a plurality of telecommunications carriers. The present system is also applied to a system that automatically plans the consolidation and elimination of existing base stations following changes in the radio wave environment accompanying redevelopment in urban areas.

As described above, the embodiment of the present invention has an extremely multifaceted and profound configuration, such as cooperative operation of a server and a terminal, multilayered utilization of generative AI, integrated analysis of enormous and diverse data, three-dimensional and intuitive visualization, immediate reflection of on-site feedback, integration of future prediction and cost evaluation, multi-carrier support, and continuous optimization in the operation stage, and is a system capable of flexibly and highly responding to all issues of a radio base station installation plan. Specifically, the present system integrally manages these plurality of technical components as loosely coupled microservices on an orchestration platform. The present system adopts a gRPC protocol for data communication between the respective modules. The present system thereby minimizes the overhead of inter-process communication. The present system schedules an inference pipeline of the generative AI using an asynchronous task queue. The present system thereby maintains a stable throughput even against a sudden spike in calculation requests. The present system develops an application on the terminal side using a cross-platform game engine. The present system thereby provides the same advanced three-dimensional visualization function for various operating systems and hardware configurations. With this comprehensive system architecture, the present system completely digitalizes a series of processes from data collection to analysis, visualization, decision making, and operation and maintenance. The present system thereby fundamentally transforms a conventional siloed business flow. As a specific application field, the present system is used as an autonomous deployment and operation management platform for ultra-high-density terahertz wave base stations for next-generation 6G communication networks. The present system is also applied to an optimization simulation of global communication coverage integrating a low earth orbit satellite constellation and a terrestrial network.

### System Configuration

The system according to the present embodiment includes a terrain data acquisition unit, a population density data acquisition unit, a radio wave propagation characteristic data acquisition unit, a generative AI processing unit, a candidate site selection unit, an AR visualization unit, a VR visualization unit, a data linkage unit, a user interface unit, and an on-site information collection unit. The terrain data acquisition unit is a unit configured to acquire terrain data from various information sources such as a geographic information system, an external map database, a satellite image provision service, drone aerial photography data, and public data of a local government, and can acquire, for example, elevation mesh data at different resolutions such as 1-meter units, 5-meter units, and 10-meter units, and selectively use them according to accuracy requirements of an installation candidate site. Furthermore, inclination angle data, classification information such as residential areas, commercial areas, industrial areas, agricultural land, forests, and rivers as land use classification data, ground strength data, soil classification data, flood and sediment disaster risk data, and the like can also be acquired, and for example, a process of automatically excluding an area with soft ground or an area with a past disaster history can be incorporated. The population density data acquisition unit is a unit configured to acquire various types of population and human flow data such as census data, basic resident register data of a local government, base station connection logs of mobile terminals, traffic flow sensor data, SNS post location information, Wi-Fi access point connection count data, commercial facility visitor count data, and event organizer visitor count data, and can grasp fluctuations in population density for each time zone or situation, such as weekdays/holidays, day/night, seasons, and during events, and reflect them in the evaluation of the installation candidate site. Furthermore, population prediction data of future urban development plans and redevelopment areas can also be acquired, enabling an installation plan anticipating future demand. The radio wave propagation characteristic data acquisition unit is a unit configured to acquire three-dimensional map data, building/tree/terrain obstacle data, communication quality logs of existing base stations, output data of a radio wave propagation simulation tool, weather data such as rainfall, snowfall, wind direction and speed, temperature, and humidity, moving object obstacle data such as vehicles and railways, and the like, and executes, for example, a radio wave propagation simulation considering the height and density of buildings and trees on a three-dimensional map to calculate a radio wave attenuation rate, a propagation loss, an influence of an obstacle, an occurrence probability of multipath and fading, and the like for each point. Furthermore, fluctuations in propagation characteristics due to weather conditions, such as an increase in attenuation during rainfall, reflection and absorption due to snowfall, and shielding fluctuations due to swaying of trees caused by strong winds, can also be considered, and communication speed, connection stability, disconnection rate, the number of complaints from users, and the like can also be acquired as actual measurement values of existing base stations, enabling an evaluation reflecting the actual situation on-site. The generative AI processing unit receives the terrain data, the population density data, and the radio wave propagation characteristic data as inputs, normalizes each data based on a minimum value and a maximum value by combining, for example, a large language model, a deep learning model, an image generation AI, a time-series analysis AI, a multimodal AI, and the like, sets an evaluation criterion for each element, for example, subtracting a normalized value of the terrain data from 1 when a lower elevation is more suitable for installation, using a normalized value of the population density data as it is when a higher population density is expected to have communication demand, and subtracting a normalized value of the radio wave propagation characteristic data from 1 when less radio wave attenuation results in a higher evaluation, further performs weighting on these elements, dynamically adjusts the weight according to an application or an operation policy such as a population density-oriented type, a terrain stability-oriented type, and a radio wave quality-oriented type, incorporates past installation record data, communication quality data, feedback from on-site personnel, and the like as learning data, and continuously improves extraction accuracy of the installation candidate site. For example, it is possible to learn communication quality and a trouble occurrence rate after installation from operation records of base stations installed in the past and reflect them in extraction of an installation candidate site under similar conditions, or automatically generate an optimal evaluation logic according to a plurality of installation purposes such as coverage expansion in urban areas, elimination of blind spots in mountainous areas, and temporary expansion at event venues. Specific examples of prompt sentences to be read by the generative AI processing unit include “Integrally analyze the following terrain data, population density data, and radio wave propagation characteristic data, calculate a total score such that a lower elevation results in a higher evaluation, a higher population density results in a higher evaluation, and less radio wave attenuation results in a higher evaluation, and extract the top 10 points in score as installation candidate sites. Output coordinates, an elevation, a population density, a radio wave propagation characteristic, and a total score for each point.” and “Prioritize extracting an area where future population growth is expected, considering past installation record data and feedback from on-site personnel.” The candidate site selection unit is a unit configured to flexibly extract the installation candidate site according to an operation policy, such as the top 10 points in score or all points exceeding a predetermined threshold, based on the total score calculated by the generative AI processing unit, organize detailed data such as coordinates, an elevation, a population density, a radio wave propagation characteristic, a total score, and surrounding environment information of each point, and transmit the detailed data to the terminal side. For example, extraction considering special circumstances for each site, such as a radio wave shielding situation in a group of high-rise buildings in an urban area, a radio wave blind spot in a valley in a mountainous area, and temporary population concentration around an event venue, is possible. The AR visualization unit is a unit configured to superimpose and display the position, recommendation degree, and various scores of the installation candidate site on a camera image of the terminal, display the position of the installation candidate site with a pin or a three-dimensional icon against the actual scenery of the site, pop-up display detailed information such as an elevation, a population density, a radio wave propagation characteristic, and a total score when each candidate site is tapped, and simultaneously compare and display a plurality of candidate sites so that an optimal installation location can be intuitively selected. For example, when on-site personnel visit the site using a tablet terminal, it becomes possible to compare and examine installation candidate sites while confirming the positional relationship of buildings, roads, and obstacles on the site in real time. The VR visualization unit is a unit configured to superimpose and display a terrain model, a building model, a population distribution heat map, a radio wave propagation simulation result, and the like in a three-dimensional virtual space using a goggle-type terminal, so that a person in charge can freely move in the virtual space and multiply confirm the surrounding environment, communication demand, and radio wave quality of each candidate site. For example, special circumstances for each site, such as a radio wave shielding situation in a group of high-rise buildings in an urban area, a radio wave blind spot in a valley in a mountainous area, and temporary population concentration around an event venue, can also be visualized three-dimensionally. The data linkage unit is a unit configured to transmit and receive terrain data, population density data, radio wave propagation characteristic data, candidate site information, on-site information, visualization data, and the like in real time between the server and the terminal to ensure data consistency and immediacy, and for example, when on-site personnel upload an on-site photograph or observation data from the terminal, the generative AI processing unit on the server side can immediately analyze it and immediately update the evaluation and extraction result of the installation candidate site. The user interface unit is a unit configured to provide an operation screen for a person in charge to browse detailed information of the installation candidate site, compare and examine it, and input feedback and additional information on the terminal, and realizes various interactions such as detailed information display for each candidate site, parallel comparison of a plurality of candidate sites, attachment of an on-site photograph, and evaluation/comment input of the installation candidate site. The on-site information collection unit is a unit configured to collect the latest on-site information and additional data using a camera, a GPS, various sensors, user input, and the like of the terminal and transmit them to the server side, and for example, collects a photograph of a newly discovered obstacle on-site, observation data of population fluctuation due to seasons, sudden event holding information, subjective evaluation and comments of on-site personnel, and the like, and the generative AI can analyze and learn these new data in real time and immediately update the evaluation and extraction result of the installation candidate site. As described above, in the system according to the present embodiment, the respective units operate in cooperation with each other, thereby efficiently and highly optimizing the selection of the installation location of the radio base station, and flexibly responding to multifaceted issues such as the actual situation on-site, future prediction, cost/risk evaluation, multi-carrier support, and continuous optimization in the operation stage. Specifically, the present system interconnects these ten functional modules via a system bus and a shared memory space. The present system implements a distributed messaging queue as the data linkage unit. The present system uses this queue to asynchronously publish and subscribe to event messages between the respective modules. The present system provides a web application based on a reactive programming paradigm as the user interface unit. Through this interface, the present system immediately reflects a user's operation event in a state management store. In the generative AI processing unit, the present system receives an “elevation data tensor”, a “population density time-series matrix”, and “three-dimensional voxel data of a radio wave propagation simulation result” as input data. The generative AI processing unit inputs these data to a neural network equipped with a multi-head attention mechanism. The generative AI processing unit outputs an “installation recommendation degree score (floating-point number from zero to one)”, a “predicted communication coverage radius (numerical value in meters)”, and a “category code of a main recommendation reason” of each coordinate as output data. The present system inputs this output result to a threshold determination circuit of the candidate site selection unit. The present system filters only coordinates whose score exceeds a predetermined threshold and transfers them to the subsequent visualization unit. Through this series of data flows, the present system automatically extracts a meaningful feature amount from an enormous amount of input data, and derives an optimal solution with speed and accuracy exceeding human cognitive limits. The present system thereby maximizes the efficiency of information processing. As a specific application field, the present system is provided as a cloud-based SaaS platform that completely automates design work of communication infrastructure. The present system is also applied to an optimal arrangement plan of a concentrator for data collection of a smart meter in a smart grid.

### IMPLEMENTATION STEPS

Step 1: Terrain Data Collection

The terrain data acquisition unit on the server side collects elevation mesh data, inclination angle data, land use classification data, ground strength data, soil classification data, flood and sediment disaster risk data, and the like from various information sources such as a geographic information system, an external map database, a satellite image provision service, drone aerial photography data, and public data of a local government. For example, high-resolution elevation data is used in urban areas, and data emphasizing inclination and ground strength is acquired in mountainous areas. Specifically, in this step, the present system issues HTTP requests in parallel to a plurality of external data sources. The present system temporarily stores the acquired raw data in GeoJSON format or TIFF format in a buffer on a memory. The present system reprojects these data to common geodetic coordinates based on a spatial reference system. The present system reconstructs the reprojected data as a three-dimensional numerical tensor on the memory. The present system stores numerical values of an elevation value, an inclination angle, and a ground strength as a vector in a channel direction for each element of this tensor. By unifying this data structure, the present system standardizes an input format to a subsequent machine learning model. The present system thereby reduces the calculation overhead of data preprocessing. As a specific application field, the present system is used for a basic data collection process for constructing a digital twin of an entire wide national land. The present system is also applied to an initial stage of a generation pipeline of a high-precision three-dimensional map for autonomous driving.
Step 2: Population Density and Human Flow Data Collection

The population density data acquisition unit on the server side acquires census data, basic resident register data of a local government, base station connection logs of mobile terminals, traffic flow sensor data, SNS post location information, Wi-Fi access point connection count data, commercial facility visitor count data, event organizer visitor count data, and the like, and grasps fluctuations in population density and human flow for each time zone or situation, such as weekdays/holidays, day/night, seasons, and during events. Population prediction data of future urban development plans and redevelopment areas is also acquired to support a long-term installation plan. Specifically, in this step, the present system activates a streaming data processing framework. The present system parses location information logs flowing in as tens of thousands of transactions per second in real time. The present system maps the parsed data to a specific geographical mesh ID using a spatial hash function. The present system counts the number of unique users for each time frame for each mesh ID. The present system writes this count result to a database as a time-series numerical array. For future prediction data, the present system applies an autoregressive moving average model to interpolate missing values. Through this dynamic data aggregation process, the present system quantifies minute changes in human flow that cannot be captured by static statistical data. The present system thereby accurately models the spatiotemporal bias of communication demand. As a specific application field, the present system is used for a system that tracks movement trajectories of evacuees in real time during a large-scale disaster and dynamically allocates communication resources. The present system is also applied to a prediction system for the number of potential customers around a store in smart retail.
Step 3: Radio Wave Propagation Characteristic Data Collection

The radio wave propagation characteristic data acquisition unit on the server side acquires three-dimensional map data, building/tree/terrain obstacle data, communication quality logs of existing base stations, output data of a radio wave propagation simulation tool, weather data (rainfall, snowfall, wind direction and speed, temperature, humidity, etc.), moving object obstacle data such as vehicles and railways, and the like. For example, the influence of special terrain and obstacles such as a group of high-rise buildings in an urban area, a valley in a mountainous area, and the surroundings of an event venue is grasped in detail. Specifically, in this step, the present system drives a ray tracing engine parallelized on a GPU cluster. The present system converts the three-dimensional map data into a bounding volume hierarchy structure and loads it into a memory. The present system radiates millions of rays from a virtual transmission antenna. The present system calculates intersection determination between each ray and a polygon at high speed using hardware acceleration. The present system calculates the intensity of a reflected wave and a diffracted wave at an intersection based on physical laws. The present system outputs this calculation result as a floating-point matrix of received power in each voxel in the space. Through this physics-based simulation, the present system replaces actual radio wave measurement work with calculations on a computer. The present system thereby reduces enormous costs and time required for measurement. As a specific application field, the present system is used for modeling a complex metal reflection environment in constructing a private 5G network in a factory. The present system is also applied to a radio wave interference simulation in the sky in a communication network between drones.
Step 4: Data Integration and Normalization Process

As a preprocessing for inputting the terrain data, the population density data, and the radio wave propagation characteristic data acquired on the server side to the generative AI processing unit, the data are normalized based on a minimum value and a maximum value so that data of different units and scales can be compared on the same standard. For example, conversion is performed according to an evaluation criterion, such as subtracting a normalized value from 1 for elevation data, using a normalized value as it is for population density data, and subtracting a normalized value from 1 for radio wave attenuation data. Specifically, in this step, the present system executes a data preprocessing pipeline. The present system scans and specifies a minimum value and a maximum value for each dimension of each data tensor. The present system applies a min-max scaling algorithm using the specified values. The present system converts all numerical values into single-precision floating-point numbers in a range from zero to one. For the elevation data, the present system collectively executes an operation of “one minus normalized value” in vector units as a value inversion process. For outliers, the present system applies a clipping process based on a Z-score to eliminate the influence of noise. Through this strict normalization process, the present system prevents vanishing gradients and exploding gradients during learning of a subsequent neural network. The present system thereby improves the convergence speed and inference accuracy of the AI model. As a specific application field, the present system is used as a preprocessing module of any IoT platform that integrates environmental data of different scales acquired from heterogeneous sensors and inputs them to a machine learning model. The present system is also applied to a system that calculates a risk score by integrating economic indicators of different units in a financial market.
Step 5: Installation Candidate Site Scoring by Generative AI

The generative AI processing unit receives the normalized terrain data, population density data, and radio wave propagation characteristic data as inputs, performs weighting on each element, and calculates a total score. The generative AI also incorporates past installation record data, feedback from on-site personnel, future population growth prediction, disaster risk information, cost information, and the like as learning data, and continuously improves extraction accuracy of the installation candidate site. For example, the weight is dynamically adjusted according to an application or an operation policy such as coverage expansion in urban areas, elimination of blind spots in mountainous areas, and temporary expansion at event venues. Specific examples of prompt sentences to be read by the generative AI include “Integrally analyze the following terrain data, population density data, and radio wave propagation characteristic data, calculate a total score such that a lower elevation results in a higher evaluation, a higher population density results in a higher evaluation, and less radio wave attenuation results in a higher evaluation, and extract the top 10 points in score as installation candidate sites. Output coordinates, an elevation, a population density, a radio wave propagation characteristic, and a total score for each point.” and “Prioritize extracting an area where future population growth is expected, considering past installation record data and feedback from on-site personnel.” Specifically, in this step, the present system executes a hybrid AI architecture integrating a large language model and a graph convolutional network. The present system receives a normalized three-dimensional tensor group and a prompt character string in natural language as input data. The present system converts the prompt character string into an integer token ID array using a tokenizer. The present system inputs this token array to an embedding layer to generate a context vector. The present system uses this context vector as a query of an attention mechanism. The present system executes a cross-attention operation using a feature amount map extracted from the tensor group as a key and a value. Through this operation, the present system dynamically changes a weight parameter of each feature amount according to instruction content of the prompt (for example, “prioritize future population growth”). The present system outputs a total score for each spatial mesh as a probability distribution as output data. The present system also outputs a feature amount contribution degree vector indicating a calculation basis of the score. The present system passes this output result to a subsequent sort processing module. Through this dynamic weighting mechanism, the present system flexibly adapts to various business requirements that cannot be handled by a fixed algorithm. The present system thereby covers countless use cases with a single system. As a specific application field, the present system is used for dynamic base evaluation according to seasonal fluctuations and fuel cost fluctuations in an optimal arrangement simulation of a distribution center in the logistics industry. The present system is also applied to scoring integrating wind condition data and environmental regulation information in selecting an installation location of a wind power generator in the renewable energy field.
Step 6: Extraction of Installation Candidate Site and Generation of Detailed Data

The candidate site selection unit extracts a point with a high score or a point exceeding a predetermined threshold as an installation candidate site based on the total score calculated by the generative AI processing unit. For each candidate site, detailed data such as coordinates, an elevation, a population density, a radio wave propagation characteristic, a total score, surrounding environment information, a disaster risk, and cost information is organized and transmitted to the terminal side. For example, it is possible to perform extraction considering special circumstances for each site, such as a radio wave shielding situation in a group of high-rise buildings in an urban area, a radio wave blind spot in a valley in a mountainous area, and a temporary population concentration around an event venue. Specifically, in this step, the system executes a top-K extraction algorithm using a priority queue data structure. The system scans total scores for millions of meshes and inserts only elements whose scores exceed the threshold into the queue. The system extracts the top K elements from the queue. The system back-calculates original latitude and longitude coordinates from an index of each extracted element. For each coordinate, the system joins text and numerical values of surrounding environment information and cost information from a relational database using an SQL query. The system serializes this joined data as a payload in a JSON format. The system transmits this payload to an IP address on the terminal side via an HTTPS protocol. By this efficient extraction and serialization process, the system instantaneously cuts out only necessary information from an enormous amount of calculation results. Thereby, the system speeds up data transfer to the terminal side while suppressing consumption of a network bandwidth. As a specific application field, the system is used as an API for high-speed search and detailed data generation of a property matching a customer's desired conditions in real estate tech. The system is also applied to a real-time distribution system to a driver of an optimal waiting place in a ride-hailing application.
Step 7: Three-Dimensional Visualization by AR/VR and On-Site Comparison and Examination

The AR visualization unit and the VR visualization unit on the terminal side display the position, recommendation degree, and various scores of the installation candidate site superimposed on a local camera image or a three-dimensional virtual space using the detailed data of the installation candidate site transmitted from the server. An on-site person in charge can confirm the position of the installation candidate site with a pin or a stereoscopic icon in an actual local landscape or a virtual space, and can browse detailed information such as an elevation, a population density, a radio wave propagation characteristic, and a total score in a pop-up display by tapping or selecting each candidate site. A plurality of candidate sites can be simultaneously compared and displayed, and an optimal installation location can be intuitively selected. Specifically, in this step, the system drives a graphics pipeline on the terminal side. The system deserializes the received JSON payload and expands the coordinate data of each candidate site into a local memory of the terminal. In an AR mode, the system applies an optical flow algorithm to a video stream of 60 frames per second acquired from a camera of the terminal to track feature points. The system detects a plane in a real space based on this feature point group, and renders a three-dimensional cylinder object indicating the candidate site semi-transparently on the plane using alpha blending. In a VR mode, the system executes stereo rendering to generate two images with parallax for left and right eyes. The system detects a raycast input from a user's controller. When a ray intersects an object, the system draws a two-dimensional UI panel including detailed information as a billboard in a three-dimensional space. By this advanced spatial computing technology, the system converts an enumeration of numerical data into spatial information that can be directly processed by a human visual cortex. Thereby, the system dramatically reduces a cognitive load on an on-site worker and eliminates a risk of an installation mistake due to misrecognition. As a specific application field, the system is used for an AR confirmation system of a piping route of an underground buried object at a construction site. The system is also applied to a surgery support system that superimposes and displays MRI data of a patient on an affected area in a medical field.
Step 8: Collection of On-Site Information and Reflection of Feedback

An on-site person in charge collects the latest local information and additional data using a camera, a GPS, various sensors, a user input, and the like of a terminal, and transmits them to the server side. For example, it is possible to collect a photograph of an obstacle newly discovered on-site, observation data of population fluctuation due to seasons, sudden event holding information, a subjective evaluation and a comment of the on-site person in charge, and the like. These new data are input to the generative AI processing unit in real time, and an evaluation of an installation candidate site and an extraction result are immediately updated. Specific examples of a prompt sentence to be read by the generative AI include “Recalculate the evaluation of the installation candidate site in consideration of the additional information acquired on-site. Reflect the new obstacle, population fluctuation, and event holding information, and re-extract the optimal installation candidate site.” Specifically, the system utilizes an asynchronous communication protocol between an edge device and a cloud server. The on-site information collection unit preprocesses an RGB image tensor acquired from the camera of the terminal. The preprocessing unit standardizes an image resolution and applies a noise reduction filter. The system encodes latitude and longitude coordinates acquired from the GPS as a floating-point vector. The system formats environmental data obtained from various sensors as a time-series array. The generative AI processing unit adopts a multimodal architecture including a large language model and a convolutional neural network. The AI processing unit receives an image tensor, a numerical vector, and an embedding vector of a natural language text as input data. For example, the input data includes a 3-channel 224×224 pixel image tensor, a two-dimensional coordinate vector, and a 512-dimensional text embedding vector. The AI processing unit projects these heterogeneous data into a common high-dimensional feature space. The AI processing unit calculates a correlation between respective features using a self-attention mechanism. The AI processing unit generates an updated suitability score of each installation candidate site as a continuous value from 0.0 to 1.0 as an output. For example, the output data includes numerical data such as a score of 0.85 for a candidate site A and a score of 0.62 for a candidate site B. The AI processing unit further outputs structured text data indicating a basis for re-evaluation. The subsequent processing unit compares the output score with a predetermined threshold. The subsequent processing unit extracts only a candidate site exceeding the threshold and updates a database. By this real-time recalculation, the system improves adaptability of the system to dynamic changes on-site. The system converts a human intuitive judgment into a quantitative parameter and integrates it into an objective evaluation process by a computer. Thereby, the system eliminates a conventional manual re-evaluation work and dramatically improves a processing speed. The system is applicable to various use cases such as not only laying of a communication infrastructure but also rapid arrangement determination of a temporary base station in the event of a disaster. The system periodically executes fine-tuning of a model based on feedback data from the site using a backpropagation method. The system updates a weight parameter so as to minimize a cross-entropy error function.
Step 9: Final Determination of Installation Plan and Continuous Optimization

An on-site person in charge or an administrator finally determines an optimal installation candidate site based on a result of comparison and examination by the AR/VR visualization unit and on-site information. Even after installation, a communication quality log, feedback from a user, operation cost data, and the like are continuously collected on the server side, and the generative AI processing unit continues to learn these operation records, whereby a future installation plan, re-evaluation of an existing base station, additional installation, a removal proposal, and the like can be automatically performed. Specifically, the system implements a continuous learning pipeline. The data collection unit periodically acquires a communication quality log from an installed base station. The communication quality log is configured as a time-series tensor including numerical data such as a throughput, a delay time, and a packet loss rate. The system processes operation cost data as a normalized floating-point array. The generative AI processing unit includes a hybrid model combining a recurrent neural network and a reinforcement learning algorithm. The AI processing unit receives a past prediction score, an actual communication quality tensor, and an operation cost vector as input data. For example, the input data includes a one-dimensional time-series array indicating 24-hour communication traffic and a three-dimensional cost vector. The AI processing unit calculates a divergence between a predicted value and an actual value. The AI processing unit inputs this divergence as a reward signal to a reinforcement learning agent. The AI processing unit generates a categorical label indicating continuous operation, parameter adjustment, additional installation, or removal of an existing base station as an output. For example, the output data includes a “parameter adjustment” label for a base station X and a “removal” label for a base station Y. The AI processing unit outputs a certainty score for each proposal as a probability distribution. The subsequent processing unit automatically transmits a proposal having a certainty score equal to or higher than a set value to an operation management system. The subsequent processing unit generates an alert to an administrator when the certainty score is low. By this feedback loop, the system continuously improves prediction accuracy of a model. The system prevents performance degradation due to environmental changes and realizes long-term optimization of computational resources. The system enables data-driven infrastructure management that does not depend on human rules of thumb. The system can be applied to a wide range of fields such as optimization of an energy grid in a smart city and dynamic rearrangement of a traffic control system. The system sequentially updates a weight of a model every time new data arrives using an online learning method. The system optimizes a loss function using a gradient descent method.

### Specific Use Case

For example, when drafting an installation plan for a new radio base station in an urban area, first, the terrain data acquisition unit acquires elevation mesh data from a geographic information system, and further collects land use classification data and ground strength data from a public database of a local government. The population density data acquisition unit acquires census data, base station connection logs of mobile terminals, traffic flow sensor data, and commercial facility visitor count data, and grasps fluctuations in population density and human flow for each time period such as weekdays/holidays, day/night, and event holding times. The radio wave propagation characteristic data acquisition unit acquires three-dimensional map data, building/tree distribution data, communication quality logs of existing base stations, output data of a radio wave propagation simulation tool, and rainfall, snowfall, wind direction and speed, etc. as weather data, and grasps in detail influences of special terrain and obstacles such as a group of high-rise buildings, an underground mall, and a complex road network in an urban area. These data are integrated on the server side, and a normalization process is performed by the generative AI processing unit. The generative AI processing unit performs weighting on each element such that a lower elevation results in a higher evaluation, a higher population density results in a higher evaluation, and less radio wave attenuation results in a higher evaluation, and calculates a total score. For example, when emphasizing coverage expansion in an urban area, a weight of a population density is set high, and weights of terrain and radio wave propagation characteristics are adjusted. The generative AI also incorporates past installation record data, feedback from on-site personnel, a future population growth prediction, disaster risk information, installation cost information, and the like as learning data to improve extraction accuracy of an installation candidate site. The candidate site selection unit extracts a point with a high score or a point exceeding a predetermined threshold as an installation candidate site based on the total score calculated by the generative AI processing unit, organizes detailed data such as coordinates, an elevation, a population density, a radio wave propagation characteristic, a total score, surrounding environment information, a disaster risk, and cost information for each candidate site, and transmits the detailed data to the terminal side. The AR visualization unit on the terminal side displays the position, recommendation degree, and various scores of the installation candidate site superimposed on a local camera image, and an on-site person in charge can compare and examine installation candidate sites while confirming a positional relationship of local buildings, roads, and obstacles in real time. The VR visualization unit displays a terrain model, a building model, a population distribution heat map, a radio wave propagation simulation result, and the like superimposed on a three-dimensional virtual space, and a person in charge can multilaterally confirm a surrounding environment, communication demand, and radio wave quality of each candidate site while freely moving in the virtual space. An on-site person in charge collects the latest local information and additional data using a camera, a GPS, various sensors, a user input, and the like of a terminal, and transmits them to the server side. For example, it is possible to collect a photograph of an obstacle newly discovered on-site, observation data of population fluctuation due to seasons, sudden event holding information, a subjective evaluation and a comment of the on-site person in charge, and the like. These new data are input to the generative AI processing unit in real time, and an evaluation of an installation candidate site and an extraction result are immediately updated. Even after installation, a communication quality log, feedback from a user, operation cost data, and the like are continuously collected on the server side, and the generative AI processing unit continues to learn these operation records, whereby a future installation plan, re-evaluation of an existing base station, additional installation, a removal proposal, and the like can be automatically performed. Specific examples of a prompt sentence to be read by the generative AI include “Integrally analyze the following terrain data, population density data, and radio wave propagation characteristic data, calculate a total score such that a lower elevation results in a higher evaluation, a higher population density results in a higher evaluation, and less radio wave attenuation results in a higher evaluation, and extract the top 10 points in score as installation candidate sites. Output coordinates, an elevation, a population density, a radio wave propagation characteristic, and a total score for each point.” and “Recalculate the evaluation of the installation candidate site in consideration of the additional information acquired on-site. Reflect the new obstacle, population fluctuation, and event holding information, and re-extract the optimal installation candidate site.” Specifically, the system includes a data integration module that synchronizes a plurality of data streams. The data integration module aligns time-series data having different sampling rates on a time axis by an interpolation process. The system maps spatial data to a three-dimensional voxel grid based on a common geodetic system. The generative AI processing unit implements a deep learning model based on a transformer architecture. The AI processing unit receives a multidimensional feature vector corresponding to each voxel as input data. For example, the input data includes a scalar value indicating an elevation, a 24-dimensional vector indicating 24-hour population fluctuation, and a tensor indicating a radio wave attenuation rate. The AI processing unit maps these feature vectors to a high-dimensional space using a multilayer perceptron. The AI processing unit calculates an interaction between spatially separated voxels by a self-attention mechanism. The AI processing unit generates a probability distribution indicating installation suitability of each voxel as an output. For example, the output data includes a suitability score of 0.92 at specific coordinates and a variance value indicating a confidence interval of the score. The AI processing unit further outputs a contribution degree of a feature amount serving as a basis for calculating the score as an attention weight. The subsequent processing unit applies a non-maximum suppression algorithm to the output probability distribution. The subsequent processing unit eliminates spatially close redundant candidate sites and extracts an independent optimal candidate site group. By this advanced spatial analysis, the system discovers a local optimal point that has been overlooked by a conventional method. The system utilizes parallel processing by a computer to significantly shorten an analysis time of wide-area urban data. The system is widely applicable to an infrastructure arrangement problem with strong spatial constraints, such as charging station arrangement for an autonomous driving vehicle and delivery port selection for a drone. In learning of a model, the system uses a contrastive learning method in which a past successful installation case is a positive example and a failure case is a negative example. The system maximizes a degree of separation between a positive example and a negative example in a feature space by minimizing a margin ranking loss function. As a data augmentation method, the system adds minute Gaussian noise to input data to improve robustness of a model.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

Embodiments for carrying out the present invention will be described more specifically, in detail, and randomly with increased thickness. In order to support optimal arrangement of urban infrastructure, the present embodiment has a configuration capable of collecting and integrating various types of data in units of grids obtained by subdividing an entire city, extracting an optimal installation candidate site using generative AI, and intuitively displaying, comparing, and examining the result by a three-dimensional visualization technology such as AR or VR. Specifically, the system converts the entire city into a hierarchical grid structure using a space division algorithm. The system adopts a quadtree data structure and divides an area with high data density at a finer resolution. The data collection unit assigns a unique identifier to each grid cell. The system manages attribute data of each cell in parallel using a distributed database. The generative AI processing unit includes an inference engine based on a graph neural network. The AI processing unit receives graph structure data in which each grid cell is a node and an adjacency relationship is an edge as input data. For example, the input data includes a feature amount matrix for each node and an adjacency matrix indicating a connection relationship of edges. The AI processing unit propagates feature information between adjacent nodes using a message passing algorithm. The AI processing unit generates a latent representation vector and a final suitability score of each node as an output. For example, the output data includes a 64-dimensional embedding vector for each grid cell and a score value normalized from 0 to 100. The subsequent processing unit clusters grid cells based on the output score value. The subsequent processing unit specifies an area where cells with high scores are concentrated as a macro candidate area. By this graph-based analysis, the system accurately models spatial continuity and a network effect between infrastructures. The system realizes global optimization considering a topology of the entire city, not limited to evaluation of a single cell. Thereby, the system eliminates waste of computational resources and dramatically improves processing efficiency for large-scale urban data. The system can be applied to a problem having a network structure, such as route design of a public transportation system and arrangement optimization of a wide-area surveillance camera network. The system extracts a hidden pattern in a graph structure using an unsupervised learning method. The system optimizes a weight of a network using a graph autoencoder so as to minimize a reconstruction error of an input graph.

The urban infrastructure data acquisition unit divides an entire city into grids at an arbitrary resolution such as 10 meters square, 25 meters square, 50 meters square, and 100 meters square, and collects various types of data for each grid. For example, elevation data is acquired from a geographic information system, a satellite image, drone aerial photography data, terrain laser scan data, land subsidence observation data, and the like, and is used for evaluation of a flood risk, a land subsidence risk, a landslide risk, and a tsunami inundation risk. For example, for a low-lying area, an area along a river, a reclaimed land, a slope, and the like in an urban area, an elevation and ground information are acquired in detail and utilized for disaster risk evaluation. Population density data is acquired from a census, a basic resident register, location information of a mobile terminal, a traffic flow sensor, SNS post location information, commercial facility visitor count data, event organizer visitor count data, Wi-Fi access point connection count data, public transportation usage data, and the like, and population fluctuation and a peak of human flow for each weekday/holiday, day/night, event holding time, and season are also grasped. For example, population dynamics for each time period and situation are finely acquired, such as a large daytime population in an office district, a large nighttime population in a residential area, and a rapid population increase in a specific period around a tourist spot or an event venue. Specifically, the urban infrastructure data acquisition unit includes a multi-scale spatial resolution processing module. This module resamples input raw data according to a specified grid size. The system applies a bilinear interpolation method to elevation data to estimate a missing value. The system uses a kernel density estimation method for population density data to convert discrete point data into a continuous probability density function. The generative AI processing unit implements a spatiotemporal convolutional network. The AI processing unit receives a four-dimensional tensor having a spatial dimension and a temporal dimension as input data. For example, the input data is a tensor consisting of a width, a height, a time step, and a feature amount channel. The AI processing unit simultaneously extracts a spatial feature and a temporal fluctuation using a three-dimensional convolution filter. The AI processing unit generates a future population fluctuation predicted value and a disaster risk score of each grid as an output. For example, the output data includes an array of predicted population densities in each time period of the next 24 hours and a flood risk probability in a range of 0.0 to 1.0. The subsequent processing unit generates a dynamic infrastructure demand map using the output predicted value. The subsequent processing unit specifies a time period and an area where demand exceeds a specific threshold, and formulates a dynamic resource allocation plan. By this spatiotemporal analysis, the system overcomes a limitation of a conventional planning method based on static data. The system anticipates an environmental change over time and enables proactive infrastructure management. Thereby, the system realizes efficient system operation that reliably satisfies demand at a peak time while preventing overinvestment. The system is optimal for a use case with severe temporal fluctuation, such as arrangement of an emergency medical facility and dynamic vehicle rearrangement of a shared cycle. The system trains a model by autoregressive learning using past time-series data. The system calculates an error between a predicted value and an actual value using a mean square error function, and updates a parameter by a gradient descent method.

Traffic flow data is acquired from a road sensor, the number of passing vehicles at an intersection, GPS data of a vehicle, the number of passengers getting on and off public transportation, the number of users of a bus stop or a station, usage data of a shared mobility service, road congestion degree data, a traffic accident occurrence history, and the like, and a place with a large flow of people and vehicles, a place where traffic congestion frequently occurs, a place with a high traffic accident risk, and the like, such as a main road, an intersection, around a station, and around a commercial facility, are specified. For example, fluctuations in traffic flow are also grasped in detail, such as during morning and evening rush hours, during an event, and during traffic regulation due to construction or an accident. Specifically, the system adopts an event-driven architecture that processes a traffic data stream in real time. The data acquisition unit stores packet data asynchronously transmitted from each sensor in a message queue. The system applies a filtering process such as a moving average and exponential smoothing using a stream processing engine. The generative AI processing unit includes a time-series prediction model including a long short-term memory network. The AI processing unit receives a multivariate time-series matrix indicating a traffic flow for a certain past period as input data. For example, the input data is a 60-by-3 matrix including the number of passing vehicles, an average speed, and a congestion degree index every minute for the past 60 minutes. The AI processing unit processes this matrix for each time step and updates a hidden state vector. The AI processing unit generates a future traffic congestion probability and an accident occurrence risk score of a target area as an output. For example, the output data includes numerical values such as a congestion occurrence probability of 85 percent within the next 30 minutes and an accident risk score of 0.75. When the output probability exceeds a specified safety threshold, the subsequent processing unit automatically activates a detour route generation module. The subsequent processing unit distributes the generated route information to a linked navigation system. By this predictive approach, the system specifies a bottleneck of a traffic infrastructure in advance and optimizes processing capacity of the entire system. The system eliminates a reactive response by a human monitor and realizes automation and speeding up of traffic control. The system is applicable to a field requiring real-time performance, such as dynamic optimization of signal control in a smart city and priority routing of an emergency vehicle. The system trains a model from a pair of past traffic data and an actual congestion/accident record using supervised learning. The system calculates a gradient in a time direction using a backpropagation through time method, and optimizes a weight of a network.

Disaster risk data is acquired from a past disaster history, a hazard map, weather data, ground information, soil classification data, flood and sediment disaster risk data, seismic motion prediction data, tsunami inundation assumption area data, a fire occurrence history, shelter location information, emergency vehicle passage route information, and the like, and risks of an earthquake, a flood, a sediment disaster, a fire, a tsunami, a storm surge, a windstorm, a lightning strike, and the like are multilaterally evaluated. For example, an area with a high disaster risk, such as an area with a river flooding history, a slope where a landslide has occurred in the past, a reclaimed land with a high liquefaction risk during an earthquake, a tsunami inundation assumption area, and a dense urban area with a large number of fire occurrences, is extracted in detail. Specifically, the system includes a semantic data integration module for integrating disaster data in heterogeneous formats. This module converts polygon data in a vector format and grid data in a raster format into a common spatial reference system. The system generates an independent risk layer for each disaster factor. The generative AI processing unit adopts an ensemble learning architecture that integrates a plurality of expert models. The AI processing unit receives a multidimensional feature tensor extracted from each risk layer as input data. For example, the input data includes a scalar value indicating a shear wave velocity of the ground, a rainfall time-series vector for the past 50 years, and a matrix indicating an elevation gradient. The AI processing unit calculates an individual risk for each disaster type using a random forest algorithm and a gradient boosting decision tree. The AI processing unit generates a comprehensive disaster vulnerability index of each point and a contribution degree of a main risk factor as an output. For example, the output data includes structured data such as a comprehensive vulnerability score of 0.88, and a flood risk contribution degree of 60 percent and a liquefaction risk contribution degree of 30 percent as a breakdown thereof. The subsequent processing unit inputs the output vulnerability index to an optimization solver as a constraint condition for infrastructure arrangement. The subsequent processing unit executes a mask process of automatically excluding an area where a vulnerability score exceeds an allowable upper limit from candidate sites. By this multilateral risk evaluation, the system accurately quantifies a risk of a complex disaster that is overlooked by a single hazard map. The system brings about a technical effect of improving durability over an entire life cycle of an infrastructure and significantly reducing a maintenance and management cost. The system can be applied to a use case requiring high robustness, such as location selection of a data center and an arrangement plan of a backup facility of an important infrastructure. The system optimizes a hyperparameter of each base learner of an ensemble model using a cross-validation method. The system learns a branch condition of each decision tree so as to minimize a logarithmic loss function.

Power grid stability data is acquired from supply grid information of a power company, past power outage history, renewable energy introduction status, presence/absence of a distributed power source, supply stability during peak power demand, location information of a transmission line and a substation, an aging status of power infrastructure, and the like, and evaluates a place where stable power supply can be expected, a place with a low power outage risk, a place where local production for local consumption of renewable energy is possible, and the like. For example, a distance from a transmission line or a substation, a past power outage frequency, an introduction status of solar power generation or a storage battery, and the like are acquired in detail. Specifically, the present system implements a graph processing module that analyzes a topology of a power network. This module models a connection relationship of transmission lines and substations as a directed graph. The present system calculates an inflow amount and an outflow amount of power at each node, and executes a power flow calculation algorithm. The present generative AI processing unit includes an anomaly detection model using a variational autoencoder. The present AI processing unit receives a multivariate time-series vector indicating a power supply state of each node as input data. For example, the input data is a 12-dimensional vector including a voltage fluctuation rate, a frequency deviation, and a past power outage duration. The present AI processing unit compresses the input data into a low-dimensional latent space using an encoder network. The present AI processing unit reconstructs original data from a latent variable using a decoder network. The present AI processing unit generates an instability score of the power grid based on a reconstruction error and a future power outage probability as an output. For example, the output data includes numerical values such as an instability score of 0.15 for node A and a power outage probability of 5 percent for the next year. The present subsequent processing unit normalizes a reciprocal of the output instability score as a power grid stability index. The present subsequent processing unit uses this index as a weighting parameter in an evaluation function for infrastructure installation. The present system mathematically guarantees reliability of energy supply during infrastructure operation by this advanced power grid analysis. The present system minimizes system downtime due to a power outage and dramatically improves service continuity. The present system is applicable to a use case where power consumption is large and stable supply is indispensable, such as arrangement of a quick charging station for an electric vehicle and selection of an edge computing base. The present system pre-trains the model using only power data during normal times. The present system defines a sum of Kullback-Leibler divergence and a reconstruction error as a loss function, and updates a network parameter so as to minimize this.

Existing infrastructure presence/absence data is acquired from an urban infrastructure management ledger, field survey data, field image analysis by a drone or an autonomous driving vehicle, operation status data from a sensor network, report data from a resident, and the like, and whether or not the same type of infrastructure is already installed, presence/absence of aging or failure, a utilization rate, a maintenance management status, and the like are also determined. For example, a position and an operation status of an existing disaster prevention base, public charging station, shared mobility port, surveillance camera, environmental sensor, and the like are grasped in detail, and utilized for extracting duplicate installation, excessive installation, and an uninstalled area. Specifically, the present system includes a spatial database engine that integrates infrastructure information from various sources. This engine links text-based management ledger data and image-based field survey data. The present system applies semantic segmentation to a high-resolution image acquired from a drone. The present generative AI processing unit implements a deep learning model based on a single-stage convolutional neural network architecture that is an object detection algorithm. The present AI processing unit receives a field image tensor and an operation status vector from a sensor as input data. For example, the input data includes a 3-channel 1024×1024 pixel image tensor and a one-dimensional array indicating an operation rate. The present AI processing unit extracts a spatial feature map from the image using a convolutional layer. The present AI processing unit generates bounding box coordinates of the existing infrastructure in the image, a class label, and a deterioration score indicating a degree of aging as an output. For example, the output data includes structured data such as a coordinate list, a class “surveillance camera”, and a deterioration score of 0.7. The present subsequent processing unit converts the output coordinate data into geospatial coordinates, and updates a distribution map of the existing infrastructure. The present subsequent processing unit calculates a coverage range of the existing infrastructure using a Voronoi diagram generation algorithm, and geometrically specifies a blank area of coverage. The present system realizes automatic infrastructure inventory independent of a manual survey by this fusion of image recognition and spatial analysis. The present system brings about a technical effect of completely eliminating duplicate investment and maximizing infrastructure arrangement efficiency within a limited budget. The present system can be applied to a field where effective utilization of an existing asset is required, such as formulation of an inspection plan for an aging bridge and optimal arrangement of a smart street light. The present system fine-tunes the model using an annotated infrastructure image dataset. The present system updates a weight so as to minimize a sum of a regression error of the bounding box and a cross-entropy error of class classification.

Furthermore, urban development plan data, land use classification data, ground strength data, event holding information, a new design plan for public transportation, urban redevelopment area information, disaster shelter location information, location information of an important infrastructure facility, emergency vehicle passage route information, land owner information, law/regulation/ordinance information, installation cost data, maintenance management cost data, a resident questionnaire result, user feedback data, usage record data after operation, and the like are also targeted for acquisition, and utilized for multifaceted optimization of urban infrastructure arrangement. Specifically, the present system adopts a data lake architecture that integrally processes structured data and unstructured data. The present system extracts a keyword and emotional polarity from a law/regulation text or a resident questionnaire using a natural language processing module. The present system formats cost data as a floating-point matrix, and inputs it to an economic evaluation module. The present generative AI processing unit includes a hybrid system combining a knowledge graph embedding model and a multi-objective optimization algorithm. The present AI processing unit receives a triple of an entity and a relation extracted from each data source, and a vector of numerical data as input data. For example, the input data includes a text triple of “Area A—Use—Commercial Area” and a scalar value indicating an initial installation cost. The present AI processing unit arranges an entity in a knowledge graph in a continuous vector space using a translating embedding method. The present AI processing unit generates a multidimensional evaluation index vector for each candidate site and a set of Pareto optimal solutions as an output. For example, the output data is vector data including a cost efficiency score of 0.8, a resident acceptability score of 0.9, and a legal conformity flag “true”. The present subsequent processing unit calculates a weighted linear sum based on a preference of a decision maker for the output Pareto optimal solution. The present subsequent processing unit calculates a final comprehensive evaluation score, and generates a ranking list of candidate sites. The present system mathematically solves a trade-off between conflicting objective functions by this integrated analysis of multidimensional data. The present system derives an optimal solution that simultaneously satisfies a complex constraint condition exceeding a human cognitive limit at high speed. The present system is applicable to a complex problem with diverse stakeholders, such as formulation of a master plan for a large-scale urban redevelopment project and optimization of tenant arrangement in a complex commercial facility. The present system searches for a Pareto front using a genetic algorithm. The present system uses a weighted sum of each evaluation index as a fitness function, and iteratively applies crossover and mutation operators to evolve a solution population.

These various types of data are input from the urban infrastructure data acquisition unit to the generative AI processing unit. The generative AI processing unit is configured by combining, for example, a large language model, a deep learning model, a time-series analysis AI, an image generation AI, a multimodal AI, a reinforcement learning AI, and the like. The generative AI normalizes each data based on a minimum value and a maximum value, and converts the data such that, for example, a lower elevation results in a higher evaluation, a higher population density results in a higher evaluation, a higher traffic flow results in a higher evaluation, a lower disaster risk results in a higher evaluation, a more stable power supply results in a higher evaluation, and an uninstalled existing infrastructure results in a higher evaluation. Furthermore, weighting can be dynamically adjusted for each installation purpose or type of urban infrastructure. For example, it can be flexibly set according to a purpose of an urban plan or an infrastructure type, such as increasing a weight of a disaster risk or power grid stability in installation of a disaster prevention base, increasing a weight of a traffic flow or a population density in installation of a shared mobility port, increasing a weight of a crime occurrence history or human flow data in installation of a surveillance camera, and increasing a weight of an air pollution risk or factory/traffic volume data in installation of an environmental sensor. The generative AI also incorporates past installation record data, feedback from on-site personnel, a future population growth prediction, disaster risk information, installation cost information, operation cost data, a maintenance management history, the number of complaints from users, communication quality data after operation, a resident questionnaire result, user feedback data, and the like as learning data, and continuously improves extraction accuracy of an installation candidate site. For example, from an operation record of infrastructure installed in the past, a utilization rate after installation, a trouble occurrence rate, a maintenance management cost, resident satisfaction, a user convenience improvement effect, and the like can be learned and reflected in extraction of an installation candidate site under a similar condition. Furthermore, long-term installation optimization looking ahead several years is also possible by taking into consideration population prediction data of an urban development plan or a redevelopment area, a future new design plan for traffic infrastructure, a disaster evacuation route or disaster shelter location information, location information of an important infrastructure facility, emergency vehicle passage route information, and the like. Specifically, the present system executes a feature engineering pipeline for unifying dimensions of input data. This pipeline applies min-max scaling to each feature amount, and maps a value to a range of 0.0 to 1.0. The present system converts categorical data into a binary vector by one-hot encoding. The present generative AI processing unit implements a multi-task learning network equipped with an attention mechanism. The present AI processing unit receives a normalized feature amount vector and a context vector indicating an infrastructure type as input data. For example, the input data includes a 256-dimensional environment feature vector and a 64-dimensional embedding vector indicating a “disaster prevention base”. The present AI processing unit calculates a dynamic attention weight for each feature amount based on the context vector. The present AI processing unit generates a comprehensive aptitude score optimized for each infrastructure type and a heatmap tensor indicating a contribution degree of each feature amount as an output. For example, the output data includes numerical values such as an aptitude score of 0.95 as a disaster prevention base and an attention weight of 0.6 for a disaster risk feature amount. The present subsequent processing unit combines the output score with spatial coordinates, and constructs a three-dimensional aptitude distribution matrix. The present subsequent processing unit inputs this matrix to a clustering algorithm, and extracts an optimal installation zone as polygon data. The present system flexibly responds to optimization requirements of various infrastructure types with a single model by this dynamic weighting mechanism. Since the present system can adapt to a new infrastructure requirement without re-learning the model, a calculation cost and a development lead time are significantly reduced. The present system can be applied to a use case where scalability is required, such as a complex infrastructure development plan in a smart city and formulation of a simultaneous deployment strategy for a plurality of services. The present system uses a weighted sum of losses of respective tasks as a loss function of multi-task learning. The present system automatically adjusts a weight of each task in a learning process using homoscedastic uncertainty.

The total score calculated by the generative AI processing unit is sent to the installation candidate site selection unit, and the installation candidate site selection unit flexibly extracts an installation candidate site according to an operation policy or a purpose of an urban plan, such as top 10 points in score or all points exceeding a predetermined threshold. For the extracted candidate site, detailed data such as coordinates, an elevation, a population density, a traffic flow, a disaster risk, a power grid stability, an existing infrastructure presence/absence, a total score, surrounding environment information, a disaster risk, cost information, a future population growth prediction, consistency with an urban development plan, a relationship with a disaster evacuation route, land owner information, law/regulation/ordinance information, a maintenance management cost, resident satisfaction, and a user convenience improvement effect of each point is organized. Specifically, the present installation candidate site selection unit executes high-speed sorting and filtering processing using an in-memory database. The present selection unit applies a quick sort algorithm to an array of the input total scores, and sorts the array in descending order. The present system dynamically reads the number of extractions or a score threshold set as an operation policy parameter. The present selection unit calculates a physical distance between the extracted points using an R-tree that is a spatial index. The present selection unit receives a score array of all grids and an attribute data dictionary of each grid as input data. For example, the input data is a floating-point array having one million elements and a structured text object including metadata corresponding to each element. When adjacent candidate sites do not satisfy a designated minimum distance constraint, the present selection unit excludes a point with a lower score by a penalty function. The present selection unit generates a structured dataset including a list of finally selected candidate sites and a detailed attribute of each candidate site as an output. For example, the output data is a list of records including a candidate site ID, latitude/longitude coordinates, a total score of 0.91, and an initial installation cost estimated value. The present subsequent processing unit serializes the output dataset into a structured text format, and transmits it to the visualization unit via a network. The present system prevents uneven distribution of infrastructure and maximizes coverage in the entire city by this selection algorithm considering a spatial constraint. The present system mathematically avoids a local excessive arrangement problem that may occur in simple extraction in order of score. The present system is applicable to a use case where maximization of coverage and minimization of cannibalization are required, such as a new store opening plan of a chain store and optimal arrangement of a logistics depot. The present system implements a heuristic algorithm based on a method of Lagrange multipliers in order to solve a constrained optimization problem. The present system efficiently discovers a solution set that maximizes an objective function while satisfying a constraint condition by an iterative search.

The visualization unit uses the candidate site data transmitted from the installation candidate site selection unit to superimpose and display a position, a recommendation degree, various scores, and a detailed attribute of the installation candidate site in an AR or VR three-dimensional space. For example, a position of a candidate site is pin-displayed on a camera image of a tablet terminal, and when each candidate site is tapped, detailed information such as an elevation, a population density, a traffic flow, a disaster risk, a power grid stability, an existing infrastructure presence/absence, a total score, cost information, resident satisfaction, and a user convenience improvement effect is pop-up displayed. If VR goggles are used, a distribution of candidate sites, a surrounding environment, a disaster risk distribution, a population density heatmap, a traffic flow distribution, an existing infrastructure distribution, an urban development plan area, an evacuation route, a position of an important infrastructure facility, an emergency vehicle passage route, and the like can be confirmed by superimposing them in multiple layers on a three-dimensional model of the entire city. Furthermore, a plurality of candidate sites can be simultaneously compared and displayed, and an optimal installation place can be intuitively selected. For example, a special circumstance for each site can also be three-dimensionally visualized, such as installation of a disaster prevention base in a high-rise building group in an urban area, installation of a shared mobility port at a traffic node in a mountainous area, installation of a surveillance camera or an environmental sensor in a temporary population concentration area around an event venue, installation of a public charging station in a redevelopment area, and infrastructure installation for disaster risk reduction around a disaster shelter. Specifically, the present visualization unit implements a rendering engine by hardware acceleration using a graphics processing unit. The present visualization unit calculates a projection matrix for converting the received candidate site data into a coordinate system of a three-dimensional space. The present system simultaneously executes self-position estimation and mapping using a gyro sensor of a terminal and an optical flow of a camera in an AR mode. The present visualization unit receives a three-dimensional coordinate vector of a candidate site, attribute data, and a posture matrix of a camera as input data. For example, the input data includes an (X, Y, Z) vector in a world coordinate system, a scalar value indicating a score, and a 4×4 transformation matrix. The present visualization unit dynamically generates a color of a pin or a particle effect according to a height of a score using a shader program. The present visualization unit generates a frame buffer in which a virtual object is superimposed on an actual camera image as an output. For example, the output data is an RGBA image tensor updated at 60 frames per second. The present subsequent processing unit processes a user's line-of-sight input or a raycast determination of a controller, and draws detailed data of the selected candidate site on a UI layer. The present system presents complex multidimensional data in a format optimized for human visual information processing by this advanced three-dimensional visualization technology. The present system promotes understanding of a spatial context, which is difficult with an enumeration of numerical data, and dramatically improves speed and accuracy of decision-making. The present system can be applied to a use case where intuitive information sharing is indispensable, such as a consensus building tool in a resident briefing session for an urban plan and an on-site instruction system from a remote location. The present system dynamically adjusts the number of polygons of a three-dimensional model according to a distance from a viewpoint using a level-of-detail control algorithm. The present system thereby optimizes a drawing load, and realizes smooth real-time rendering even on a mobile terminal.

In addition, if on-site personnel inputs a new obstacle, a population fluctuation, event holding information, a request from a resident, observation data at a site, a field photograph, a user's action log, or the like from a terminal at the site, the information is reflected in the generative AI on the server side in real time, and an evaluation or an extraction result of an installation candidate site is immediately updated. For example, a photograph of a newly discovered obstacle at a site, observation data of a population fluctuation due to a season, sudden event holding information, a subjective evaluation or a comment of on-site personnel, a request or a complaint from a resident, a user's action log, and the like are collected, and the generative AI can analyze and learn these new data in real time, and immediately update an evaluation or an extraction result of an installation candidate site. Specifically, the present system utilizes a WebSocket protocol that establishes bidirectional real-time communication between an edge device and a cloud. The present field information collection unit passes input text data to a natural language processing pipeline, and executes morphological analysis and named entity extraction. The present system inputs an uploaded field photograph to a convolutional neural network, and extracts an image feature vector. The present generative AI processing unit includes a dynamic update module implementing an online learning algorithm. The present AI processing unit receives a newly acquired image feature vector, a text embedding vector, and a time-series array of observation data as input data. For example, the input data includes a 512-dimensional image feature vector, a 768-dimensional text embedding vector, and a timestamp indicating a start/end time of an event. The present AI processing unit collates these new data with an existing knowledge base, and locally updates a feature amount tensor of a related grid cell. The present AI processing unit generates a difference vector of a new aptitude score based on the updated feature amount as an output. For example, the output data includes an update command indicating that a score of a specific grid has increased by +0.15. The present subsequent processing unit incrementally updates a database using this difference vector, and push-transmits a re-rendering instruction for a changed area to the visualization unit. The present system instantaneously fills a gap between static prior data and a dynamic field situation by this real-time feedback loop. The present system eliminates a delay due to batch processing, and shortens responsiveness of the system to a situation change to a millisecond unit. The present system is applicable to a use case where a time constraint is extremely strict, such as dynamic correction of an emergency infrastructure restoration plan when a disaster occurs and real-time optimization of a crowd guidance system during a large-scale event. The present system sequentially updates a weight of a model for new data with a minute learning rate using a stochastic gradient descent method. The present system performs learning in combination with a replay buffer that holds past important data in order to prevent catastrophic forgetting.

Furthermore, for example, taking into consideration a disaster evacuation route or disaster shelter location information, an emergency vehicle passage route, a position of an important infrastructure facility, an urban development plan area, a redevelopment area, a new design plan for public transportation, land owner information, law/regulation/ordinance information, an installation cost or a maintenance management cost, resident satisfaction, a user convenience improvement effect, and the like, the generative AI can also automatically propose an installation plan in which an urban function is easily maintained even during a disaster, an installation plan capable of flexibly responding to future urban growth or a demographic change, an installation plan that maximizes cost efficiency or resident satisfaction, and the like. Furthermore, when optimally arranging a plurality of urban infrastructure types (for example, a disaster prevention base, a public charging station, a shared mobility port, a surveillance camera, an environmental sensor, etc.) simultaneously, an evaluation criterion or weighting is individually set for each infrastructure type, and the generative AI considers a mutual arrangement balance, an interference risk, a possibility of shared installation, a synergistic effect of complex infrastructure, and the like, and can also automatically generate an optimal complex arrangement plan. Furthermore, even in an operation stage after installation, the generative AI continuously learns a usage record, an operation cost, resident satisfaction, user feedback, a maintenance management history, the number of complaints from users, and the like, and can also automatically perform re-evaluation of an installation place, additional installation, a removal proposal, an operation improvement proposal, and the like as necessary. Specifically, the present system implements an evolutionary computation engine that simultaneously optimizes a plurality of objective functions. This engine encodes an arrangement pattern of each infrastructure type as a chromosome, and executes a genetic algorithm. The present system formulates physical interference or radio wave interference between infrastructures as a penalty function. The present generative AI processing unit includes a multi-agent system based on deep reinforcement learning. The present AI processing unit receives a multidimensional state tensor indicating a current state of a city and an action history vector of each agent as input data. For example, the input data includes a three-dimensional tensor indicating an attribute of an urban grid and a coordinate list indicating a current position of each infrastructure. In the present AI processing unit, each agent is in charge of arrangement of a specific infrastructure type, and learns a cooperative action among agents. The present AI processing unit generates a set of optimal arrangement coordinates of each infrastructure and a prediction of a future expected reward value by the arrangement as an output. For example, the output data includes coordinate data indicating shared installation of a disaster prevention base and a charging station, and a utility score of 0.94 for the entire system. The present subsequent processing unit inputs the output arrangement plan to a simulation environment, and automatically executes a stress test when a disaster occurs. The present subsequent processing unit verifies robustness of the arrangement plan based on a simulation result, and adopts only a plan satisfying a criterion as a final output. The present system derives an optimal solution as a system of systems for the entire city, which cannot be reached by optimization of a single infrastructure, by this multi-agent reinforcement learning. The present system produces an enormous economic effect by preventing siloing of infrastructure and eliminating duplication of capital investment. The present system can be applied to design of an extremely complex composite system, such as overall design of a smart city and optimal arrangement of limited resources in a space station. The present system models an environment based on a Markov decision process, and approximates an action value function using a Q-learning algorithm. The present system samples past transition data using an experience replay memory, and stabilizes learning of a neural network.

As described above, the embodiment of the present invention realizes extremely multifaceted and profound technical effects such as efficiency improvement, sophistication, cost reduction, disaster response capability improvement, future prediction response, immediate reflection of field feedback, complex optimization of a plurality of infrastructure types, resident satisfaction improvement, operation cost optimization, and flexible response to urban growth of an urban infrastructure arrangement plan by the urban infrastructure data acquisition unit, the generative AI processing unit, the installation candidate site selection unit, and the visualization unit operating in cooperation, integrally analyzing various types of data of an entire city area, extracting an optimal installation candidate site for each installation purpose or infrastructure type, and providing an environment where comparative examination can be intuitively performed in a three-dimensional space. Specifically, the present system connects respective modules with a microservice architecture, and ensures high scalability and fault tolerance. The present system controls data communication between respective units by asynchronous messaging via an API gateway. The present system dynamically scales out an instance of the generative AI processing unit according to a calculation load using a container orchestration tool. The present system receives a metrics vector indicating throughput, latency, and a resource usage rate of the entire system as input data. For example, the input data includes numerical values such as a CPU usage rate of 85 percent, a memory usage amount of 16 gigabytes, and an average response time of 120 milliseconds. The present system collects these metrics in real time by a monitoring agent, and inputs them to an anomaly detection algorithm. The present system generates a resource allocation change command or an automatic failover instruction when a failure occurs as an output. For example, the output data includes a control signal instructing activation of a new container and a traffic routing change rule. The present subsequent processing unit transmits the output command to an infrastructure management API, and autonomously optimizes a system configuration. The present system maintains stable performance even in large-scale urban data processing by this autonomous system management. The present system brings about a technical effect of maximizing utilization efficiency of a hardware resource and significantly reducing an operation cost of cloud computing. The present system is applicable to a mission-critical large-scale system such as a nation-scale wide-area infrastructure management platform and a global logistics network optimization system. The present system encodes an architecture of the entire system as a software-defined infrastructure, and realizes continuous integration and continuous deployment in cooperation with a version control system. The present system thereby enables rapid deployment of a new function and rapid rollback when a failure occurs.

### System Configuration

The system according to the present embodiment comprises an urban infrastructure data acquisition unit, a generative AI processing unit, an installation candidate site selection unit, a visualization unit, an on-site information collection unit, a data linkage unit, and a user interface unit. The urban infrastructure data acquisition unit is a unit configured to divide an entire city into grids at an arbitrary resolution such as 10 meters square, 25 meters square, 50 meters square, or 100 meters square, and collect various types of data for each grid, and for example, acquires elevation data from a geographic information system, a satellite image, drone aerial photography data, terrain laser scan data, or land subsidence observation data, and uses the elevation data for evaluating a flood risk, a land subsidence risk, a landslide risk, or a tsunami inundation risk. Furthermore, the urban infrastructure data acquisition unit acquires population density data from a census, a basic resident register, location information of a mobile terminal, a traffic flow sensor, SNS post location information, commercial facility visitor count data, event organizer visitor count data, Wi-Fi access point connection count data, or public transportation usage data, and also grasps population fluctuations and human flow peaks for each of weekdays/holidays, day/night, event holding times, and seasons. The urban infrastructure data acquisition unit acquires traffic flow data from a road sensor, the number of passing vehicles at an intersection, GPS data of a vehicle, the number of passengers getting on and off public transportation, the number of users of a bus stop or a station, usage data of a shared mobility service, road congestion degree data, or a traffic accident occurrence history, and specifies a place with a large flow of people or vehicles, a place where traffic congestion frequently occurs, a place with a high traffic accident risk, or the like, such as a main road, an intersection, around a station, or around a commercial facility. The urban infrastructure data acquisition unit acquires disaster risk data from a past disaster history, a hazard map, weather data, ground information, soil classification data, flood and sediment disaster risk data, ground motion prediction data, tsunami inundation assumption area data, a fire occurrence history, shelter location information, or emergency vehicle passage route information, and multilaterally evaluates risks such as an earthquake, a flood, a sediment disaster, a fire, a tsunami, a storm surge, a windstorm, and a lightning strike. The urban infrastructure data acquisition unit acquires power grid stability data from supply grid information of a power company, a past power outage history, a renewable energy introduction status, presence/absence of a distributed power source, supply stability at a peak power demand, location information of a transmission line/substation, or an aging status of power infrastructure, and evaluates a place where stable power supply can be expected, a place with a low power outage risk, a place where local production for local consumption of renewable energy is possible, or the like. The urban infrastructure data acquisition unit acquires existing infrastructure presence/absence data from an urban infrastructure management ledger, field survey data, field image analysis by a drone or an autonomous driving vehicle, operation status data from a sensor network, or report data from a resident, and also determines whether or not the same type of infrastructure has already been installed, presence/absence of aging or failure, a usage rate, a maintenance management status, and the like. Furthermore, urban development plan data, land use classification data, ground strength data, event holding information, a new establishment plan for public transportation, urban redevelopment area information, disaster shelter location information, location information of an important infrastructure facility, emergency vehicle passage route information, land owner information, legal regulation/ordinance information, installation cost data, maintenance management cost data, a resident questionnaire result, user feedback data, usage record data after operation, and the like are also targeted for acquisition, and are utilized for multilateral optimization of urban infrastructure arrangement. Specifically, the system implements a distributed messaging queue that integrates asynchronous streams from respective data sources. The data linkage unit functions as a protocol conversion gateway, and converts different communication standards into a unified internal format. The system caches sensor data updated at a high frequency with low latency using an in-memory data grid. The urban infrastructure data acquisition unit maps coordinates of each grid to a one-dimensional index key using a spatial hash algorithm. The system receives a binary payload transmitted from each sensor node as input data. For example, the input data is 128-byte packet data including a sensor ID, a timestamp, and a measurement value. The system decodes this payload and updates an attribute table of the corresponding grid. The system generates a multidimensional state tensor reflecting the latest state of all grids as an output. For example, the output data is a tensor having a spatial resolution of 1000×1000 covering the entire city and feature amounts of 64 channels. The subsequent processing unit writes this state tensor into a shared memory area of the generative AI processing unit at a constant cycle. The system acquires an ability to process petabyte-class urban data in real time by this advanced data pipeline. The system eliminates data silos and dramatically improves data consistency and availability of the entire system. The system can be applied to a use case requiring ultra-large-scale and low-latency data processing, such as a wide-area control system for autonomous driving vehicles or real-time supply and demand adjustment of a smart grid. The system guarantees data integrity while minimizing consumption of a network bandwidth using a data compression algorithm. The system adds a parity check and an error correction code, and automatically repairs a data loss on a communication path.

The generative AI processing unit is a unit configured to analyze the various types of data input from the urban infrastructure data acquisition unit by combining, for example, a large language model, a deep learning model, a time-series analysis AI, an image generation AI, a multimodal AI, a reinforcement learning AI, and the like, normalize each data based on a minimum value and a maximum value, convert the data such that a lower elevation results in a higher evaluation, a higher population density results in a higher evaluation, a higher traffic flow results in a higher evaluation, a lower disaster risk results in a higher evaluation, a more stable power supply results in a higher evaluation, and an uninstalled existing infrastructure results in a higher evaluation, and dynamically adjust weighting for each installation purpose or type of urban infrastructure. For example, it can be flexibly set according to the purpose of urban planning or the type of infrastructure, such as increasing the weight of the disaster risk or the power grid stability in the installation of a disaster prevention base, increasing the weight of the traffic flow or the population density in the installation of a shared mobility port, increasing the weight of a crime occurrence history or human flow data in the installation of a surveillance camera, and increasing the weight of an air pollution risk or factory/traffic volume data in the installation of an environmental sensor. Furthermore, past installation record data, feedback from on-site personnel, a future population growth prediction, disaster risk information, installation cost information, operation cost data, a maintenance management history, the number of complaints from users, communication quality data after operation, a resident questionnaire result, user feedback data, and the like are also incorporated as learning data to continuously improve extraction accuracy of the installation candidate site. For example, from the operation record of the infrastructure installed in the past, a usage rate after installation, a trouble occurrence rate, a maintenance management cost, resident satisfaction, a user convenience improvement effect, and the like can be learned and reflected in the extraction of the installation candidate site under similar conditions. Specific examples of a prompt sentence to be read by the generative AI include “Integrally analyze elevation data, population density data, traffic flow data, disaster risk data, power grid stability data, and existing infrastructure presence/absence data included in the following city map, and extract the top 10 points optimal for installing a disaster prevention base. Output coordinates, an elevation, a population density, a traffic flow, a disaster risk, a power grid stability, an existing infrastructure presence/absence, and a total score for each point.” and “Extract an optimal candidate site for installing a shared mobility port with an emphasis on a traffic flow and a population density.” Specifically, the generative AI processing unit comprises an orchestration engine that integrates a plurality of neural network models. The engine dynamically routes an appropriate sub-model according to a modality of the input data. The system converts a natural language prompt into a sequence of integers by a tokenizer, and inputs the sequence to an embedding layer. The AI processing unit receives a tokenized prompt vector and a multidimensional feature tensor of the city map as input data. For example, the input data includes a 512-dimensional prompt embedding vector and a 256×256×64 spatial feature tensor. The AI processing unit calculates a relevance between instruction content of text and a spatial feature using a cross-attention mechanism. The AI processing unit dynamically changes an activation function parameter for each feature channel based on a condition such as “disaster prevention base” or “shared mobility port” specified in the prompt. The AI processing unit generates an aptitude score map of each grid and a structured list of the extracted top points as an output. For example, the output data is a 256×256 probability map and an array in a structured text format including coordinates and scores of the top 10 points. The subsequent processing unit applies a Gaussian smoothing filter to the output probability map to remove noise. The subsequent processing unit detects a local maximum value from the smoothed map, and determines final candidate site coordinates. The system enables even a city planner without programming knowledge to execute advanced AI analysis by this fusion of the natural language interface and deep learning. The system eliminates manual tuning work of parameters, and dramatically shortens a lead time from requirement definition to result output. The system is applicable to a use case requiring a flexible interface, such as an interactive decision-making support system at the time of a disaster or a citizen-participatory urban planning simulator. The system fine-tunes the model using user feedback as a reward signal by using a policy gradient method in reinforcement learning. The system adopts a proximal policy optimization algorithm, and achieves both learning stability and a convergence speed.

The installation candidate site selection unit is a unit configured to flexibly extract an installation candidate site according to an operation policy or a purpose of urban planning, such as the top 10 points in score or all points exceeding a predetermined threshold, based on the total score calculated by the generative AI processing unit, and for the extracted candidate site, organizes detailed data such as coordinates, an elevation, a population density, a traffic flow, a disaster risk, a power grid stability, an existing infrastructure presence/absence, a total score, surrounding environment information, a disaster risk, cost information, a future population growth prediction, consistency with an urban development plan, a relationship with an evacuation route at the time of a disaster, land owner information, legal regulation/ordinance information, a maintenance management cost, resident satisfaction, and a user convenience improvement effect of each point. Specifically, the installation candidate site selection unit implements an online analytical processing engine using a multidimensional data cube. The selection unit stores the calculated total score in a fact table, and relationally joins each attribute data as a dimension table. The system dynamically converts an operation policy parameter set by a user into a query of a structured query language. The selection unit receives a score data set of all grids and an extraction condition parameter as input data. For example, the input data includes a record group of millions of rows and a logical expression “score of 0.8 or more and initial cost of 10 million or less”. The selection unit drives a parallel query execution engine on an in-memory database, and scans a record matching the condition at high speed. The selection unit generates a data frame of filtered and sorted candidate sites as an output. For example, the output data is a tabular data structure in which each attribute value of the top 10 points is organized as a column. The subsequent processing unit serializes the output data frame, and transfers it to the visualization unit or an external report generation system. The system instantaneously extracts an optimal subset from a huge candidate site group by this advanced database processing technology. The system reduces a calculation order of a search process involving a complex constraint condition, and dramatically improves response performance of the system. The system can be applied to a use case in which a conditional search from large-scale data frequently occurs, such as an automatic matching system for real estate properties or optimal warehouse selection in a wide-area supply chain. The system minimizes an overhead of disk IO by early excluding data out of a search target using a Bloom filter. The system caches an execution plan of a frequently executed query, and further speeds up a search process from the next time onward.

The visualization unit is a unit configured to superimpose and display a position, a recommendation degree, various scores, and detailed attributes of an installation candidate site in an AR or VR three-dimensional space using candidate site data transmitted from the installation candidate site selection unit, and for example, displays the position of the candidate site as a pin on a camera image of a tablet terminal, and when each candidate site is tapped, detailed information such as an elevation, a population density, a traffic flow, a disaster risk, a power grid stability, an existing infrastructure presence/absence, a total score, cost information, resident satisfaction, and a user convenience improvement effect is pop-up displayed. If VR goggles are used, a distribution of candidate sites, a surrounding environment, a disaster risk distribution, a population density heat map, a traffic flow distribution, an existing infrastructure distribution, an urban development plan area, an evacuation route, a position of an important infrastructure facility, an emergency vehicle passage route, and the like can be confirmed by being superimposed in multiple layers on a three-dimensional model of the entire city. Furthermore, a plurality of candidate sites can be simultaneously compared and displayed, and an optimal installation location can be intuitively selected. Specifically, the visualization unit operates by linking a dedicated graphics processing unit and a neural network accelerator on an edge device. The visualization unit goes beyond simple drawing processing of three-dimensional graphics, and executes dynamic rendering optimization processing using artificial intelligence. Conventional augmented reality and virtual reality systems have had a technical problem of causing depletion of calculation resources and a decrease in frame rate because huge polygon data and texture data are always drawn at the highest resolution. In order to solve this problem, the visualization unit implements a rendering optimization artificial intelligence architecture integrating a plurality of deep learning models specialized for line-of-sight prediction and spatial recognition. The visualization unit first acquires environmental data from a depth sensor and a camera mounted on the terminal. Input data to the spatial recognition artificial intelligence model is an RGB image tensor with a resolution of 1024 by 1024, a depth map tensor with the same resolution, and time-series array data of six degrees of freedom obtained from an inertial measurement unit. Specific examples of the input data include depth data indicating an arrangement of indoor walls and furniture, image data indicating outlines of outdoor buildings and street trees, and acceleration data of a head accompanying walking of a user. The spatial recognition artificial intelligence model processes these input data using a convolutional neural network. Output data from the spatial recognition artificial intelligence model is a semantic label for each voxel in the three-dimensional space, a probability distribution map of an occlusion boundary, and an estimation vector of environmental light. Specific examples of the output data include an occlusion mask value indicating an area of a virtual object that is hidden by a real building and cannot be seen, numerical values of a direction and an intensity of a light source to be applied to the virtual object, and a category identifier for identifying a floor surface or a wall surface. The visualization unit inputs this output result to a subsequent occlusion culling process and a lighting calculation module. The visualization unit accurately omits drawing of a virtual object hidden by a real object on a pixel-by-pixel basis. Thereby, the visualization unit dramatically reduces a useless drawing load of the graphics processing unit. Furthermore, the visualization unit executes a line-of-sight prediction artificial intelligence model that predicts a line-of-sight direction of the user. Input data to the line-of-sight prediction artificial intelligence model is a time-series array of two-dimensional coordinates of a pupil acquired from an eye tracking sensor, and quaternion data of a head posture. Specific examples of the input data include line-of-sight movement trajectory data for the past 500 milliseconds, dwell time data when gazing at a specific virtual object, and angular velocity data indicating a rapid rotation of the head. The line-of-sight prediction artificial intelligence model adopts a transformer architecture. The line-of-sight prediction artificial intelligence model predicts a movement destination of the line of sight using a self-attention mechanism. Output data from the line-of-sight prediction artificial intelligence model is a gaze probability distribution map for each area on a screen, and a numerical vector of an importance score for each virtual object. Specific examples of the output data include center coordinates of an area where a probability that the user will gaze next exceeds 90 percent, a low importance score for an object located in a peripheral part of a visual field, and a high priority value for detailed information to be pop-up displayed. The visualization unit inputs this output result to a subsequent level-of-detail control module. The visualization unit draws a virtual object in an area with a high gaze probability with a high-resolution polygon model and a high-definition texture. The visualization unit applies a simplified model with a reduced number of polygons to an area of a peripheral visual field with a low gaze probability. The visualization unit significantly reduces a calculation amount of drawing processing without degrading visual quality by this foveated rendering method. In learning of these artificial intelligence models, the visualization unit executes supervised learning using a large amount of line-of-sight tracking data and three-dimensional environmental data. This learning process updates weights of a network so as to minimize a mean square error between a predicted line-of-sight position and an actual line-of-sight position. The visualization unit applies random noise addition to an input image or a temporal shift of line-of-sight data as a data augmentation method. Thereby, the visualization unit improves generalization performance of the model for an unknown user or various environments. By these technical processes provided by the visualization unit, the system stably maintains a frame rate at 90 frames per second or more. The visualization unit suppresses a drawing delay to 20 milliseconds or less. As a result, the visualization unit effectively prevents video sickness of the user in a virtual reality environment. Even when simultaneously comparing and displaying a plurality of candidate sites, the visualization unit dynamically adjusts an information amount according to the line of sight of the user. The visualization unit reduces a cognitive load of the user. A specific application field of the visualization unit includes a simulation task in which a person in charge of urban planning evaluates a large number of communication infrastructure installation candidate sites on a three-dimensional model of a vast city. The visualization unit is also applicable to a disaster countermeasure use case in which a passage route of an emergency vehicle or an evacuation route and an operation status of communication infrastructure are superimposed and displayed when a disaster occurs. Even in augmented reality display using a tablet terminal, the visualization unit links an artificial intelligence model with a self-position estimation and environmental map creation algorithm that simultaneously performs self-position estimation of a camera and environmental mapping. The visualization unit aligns a coordinate system of a real space and a coordinate system of a virtual space with an accuracy in units of millimeters. The visualization unit realizes natural information presentation that blends into a real landscape. The visualization unit provides an adaptive interface that understands an intention of the user and a context of the environment, rather than a mere enumeration of information. The visualization unit fundamentally improves graphics processing efficiency of a computer and operability of a user interface.

The on-site information collection unit is a unit configured to allow on-site personnel to input a new obstacle, a population fluctuation, event holding information, a request from a resident, observation data on site, an on-site photograph, an action log of a user, and the like on site from a terminal, and reflect these pieces of information in the generative AI on the server side in real time, and can immediately update an evaluation and an extraction result of an installation candidate site. For example, a photograph of a newly discovered obstacle on site, observation data of a population fluctuation due to a season, sudden event holding information, a subjective evaluation or comment of on-site personnel, a request or complaint from a resident, an action log of a user, and the like are collected, and the generative AI analyzes and learns these new data in real time, and immediately updates the evaluation and the extraction result of the installation candidate site. Specifically, the on-site information collection unit is implemented as a dedicated application running on an edge device. The on-site information collection unit acquires multimedia data from a camera module or a GPS sensor of the terminal. The on-site information collection unit converts the acquired image data into, for example, an RGB image tensor of 224 pixels square. The on-site information collection unit converts text input data into a word embedding vector for natural language processing. The on-site information collection unit transmits these preprocessed data to the generative AI processing unit on the server side via a secure communication protocol. The generative AI processing unit adopts a multimodal transformer architecture. The generative AI processing unit maps the input image tensor and text vector to the same high-dimensional feature space. The generative AI processing unit receives, for example, an image tensor of a building newly under construction and a text vector indicating that there is an obstacle with a height of 50 meters as inputs. The generative AI processing unit outputs an environmental fluctuation vector including three-dimensional coordinates and an attenuation coefficient of the obstacle from these inputs. The generative AI processing unit adds the output environmental fluctuation vector to a weight parameter of an existing urban environment model. The system recalculates an evaluation score of the installation candidate site by this parameter update. The system automatically excludes the candidate site when the recalculated score falls below a predetermined threshold. The system dramatically improves immediacy of evaluation by this dynamic update process compared to a conventional batch process depending on manual input by a human. The system reflects the latest situation on site in the model with a delay in units of several milliseconds. Thereby, the system prevents a decrease in accuracy in an installation plan of communication infrastructure. The system exhibits an extremely high technical effect in a use case such as temporary base station installation at the time of a disaster or mobile base station arrangement at the time of an event.

The data linkage unit is a unit configured to transmit and receive data in real time among the urban infrastructure data acquisition unit, the generative AI processing unit, the installation candidate site selection unit, the visualization unit, the on-site information collection unit, and the user interface unit, and ensure data consistency and immediacy, and when on-site personnel upload an on-site photograph or observation data from a terminal, the generative AI processing unit on the server side can immediately analyze the data, and immediately update an evaluation and an extraction result of an installation candidate site. Specifically, the data linkage unit is configured using a distributed messaging queue system and an in-memory database. The data linkage unit establishes asynchronous and high-throughput data stream communication among the respective processing units. The data linkage unit adopts a publish-subscribe model. The data linkage unit publishes an image tensor or a text vector transmitted from the on-site information collection unit to a specific topic. The generative AI processing unit subscribes to the topic and immediately acquires new data. The data linkage unit adds a timestamp and spatial coordinate metadata to a data packet. The data linkage unit spatiotemporally synchronizes asynchronous data from a plurality of sources using this metadata. The data linkage unit combines, for example, an image tensor of a point A at a time T1 and a sensor data vector of the point A at a time T2 within the same time window. The data linkage unit inputs this combined multidimensional tensor to the generative AI processing unit. The generative AI processing unit analyzes this multidimensional tensor and outputs the latest environmental evaluation score of the point A. The data linkage unit transfers this evaluation score to the installation candidate site selection unit and the visualization unit in units of milliseconds. The system reduces a degree of coupling among modules of the entire system by this asynchronous messaging architecture. Thereby, the system prevents a delay of the entire system even when a load is concentrated on a specific processing unit. The system realizes large-scale parallel processing while maintaining data consistency. The system brings about technical effects of reducing a communication load and improving a processing speed in a use case such as a real-time traffic control system or dynamic reconfiguration of a wide-area monitoring network in a smart city.

The user interface unit is a unit configured to provide an operation screen for a person in charge to browse detailed information of an installation candidate site, compare and examine the detailed information, and input feedback or additional information on a terminal, and realizes various interactions such as detailed information display for each candidate site, parallel comparison of a plurality of candidate sites, attachment of an on-site photograph, evaluation/comment input of an installation candidate site, input of a resident questionnaire result, and collection of user feedback, for example. Specifically, the user interface unit executes dynamic rendering by utilizing a graphics processing unit of an edge terminal. The user interface unit parses an evaluation score or three-dimensional coordinate data of an installation candidate site received from a server as structured data in a JSON format. The user interface unit generates a polygon mesh in a three-dimensional space based on this structured data. The user interface unit applies a color map according to the evaluation score to the generated polygon mesh. The user interface unit draws, for example, a point with a high score as a red heat map. The user interface unit acquires a touch input or a gesture input from a user as a two-dimensional screen coordinate vector. The user interface unit converts this screen coordinate vector into a raycast vector in the three-dimensional space. The user interface unit executes intersection determination between this raycast vector and the polygon mesh. The user interface unit specifies a specific installation candidate site selected by the user by this intersection determination. The user interface unit overlay-displays a detailed attribute vector regarding the specified candidate site on a screen. The user interface unit inputs a text comment input by the user to a natural language processing model. The natural language processing model outputs an emotion polarity score or an importance weight from this text. The user interface unit transmits this output score to the server as feedback data. The system significantly reduces a cognitive load of a human by this intuitive three-dimensional interaction. The system streamlines comparison and examination work of complex multidimensional data. The system provides technical effects of reducing an operation error and speeding up decision-making in a use case such as an urban planning simulator or an infrastructure maintenance and inspection application.

As described above, the system according to the present embodiment realizes extremely multilateral and profound technical effects such as efficiency improvement, sophistication, cost reduction, disaster response capability improvement, future prediction response, immediate reflection of on-site feedback, complex optimization of a plurality of infrastructure types, resident satisfaction improvement, operation cost optimization, and flexible response to urban growth of an urban infrastructure arrangement plan by the urban infrastructure data acquisition unit, the generative AI processing unit, the installation candidate site selection unit, the visualization unit, the on-site information collection unit, the data linkage unit, and the user interface unit operating in cooperation, integrally analyzing various types of data of an entire city, extracting an optimal installation candidate site for each installation purpose or infrastructure type, and providing an environment in which intuitive comparison and examination can be performed in a three-dimensional space. Specifically, the system constructs a distributed computing environment in which each processing unit operates independently as a microservice architecture. The system integrates petabyte-class heterogeneous mixed data collected from the entire city as a high-dimensional tensor. The system inputs this high-dimensional tensor to a deep neural network of the generative AI processing unit. The generative AI processing unit extracts a latent feature vector from the input high-dimensional tensor. The generative AI processing unit outputs an infrastructure installation aptitude probability distribution of each grid using this latent feature vector. The system determines an optimal installation candidate site based on this probability distribution. The system completely eliminates a conventional heuristic rule-based selection method by a human. The system adopts a data-driven unconventional procedure by a machine learning model. The system specifies a non-linear correlation among multivariates unrecognizable by a human by this unconventional procedure. The system learns a hidden correlation between, for example, a minute change in traffic flow and a local spike in communication traffic under a specific weather condition. The system predicts a future traffic demand using this learning result, and calculates an optimal base station arrangement. The system eliminates waste of calculation resources by this process, and dramatically improves calculation efficiency of the entire system. The system is applied to a use case such as roadside unit arrangement optimization for an autonomous driving vehicle or an arrangement plan of a distributed power source in a smart grid. The system brings about an extremely important technical effect of maximizing coverage while suppressing excessive investment in infrastructure in these use cases.

### IMPLEMENTATION STEPS

Step 1: Urban Grid Division and Basic Data Collection

An entire city is divided into grids at an arbitrary resolution such as 10 meters square, 25 meters square, 50 meters square, or 100 meters square, and various types of data such as elevation data, population density data, traffic flow data, disaster risk data, power grid stability data, existing infrastructure presence/absence data, land use classification data, ground strength data, event holding information, public transportation usage data, urban development plan data, legal regulation/ordinance information, land owner information, installation cost data, maintenance management cost data, a resident questionnaire result, user feedback data, and usage record data after operation are collected for each grid from a geographic information system, a satellite image, drone aerial photography, a traffic sensor, operation data of public transportation, an urban infrastructure management ledger, field survey data, report data from a resident, various administrative databases, or the like. Specifically, the system discretizes a geographical space of the entire city into a three-dimensional voxel grid space. The system allocates a unique spatial index to each voxel. The system generates a multidimensional feature amount vector by linking the collected various types of data to this spatial index. The system acquires, for example, elevation data as a floating-point number. The system acquires land use classification data as a one-hot encoded categorical vector. The system acquires traffic flow data as a time-series numerical array. The system combines these heterogeneous data to construct, for example, a 256-dimensional initial feature amount vector for each voxel. The system extracts an outline or a height of a building from a drone aerial photography image using a convolutional neural network, and converts it into numerical data. The system inputs legal regulation information described in a natural language to a large language model, and converts it into a semantic embedding vector. The system concatenates these converted data to the initial feature amount vector. In this way, the system converts physical and social characteristics of the city into a completely digitized tensor representation. The system provides a data structure that can be directly calculated by a subsequent machine learning model by this tensorization process. The system eliminates the need for a conventional visual confirmation work of a map by a human. The system dramatically improves efficiency of data management by automating a process of data collection and structuring. The system exhibits a technical effect of significantly shortening a calculation time required for data preparation in a use case such as a wide-area urban development simulation or damage prediction modeling at the time of a disaster.
Step 2: Data Preprocessing and Normalization For the collected various types of data, a normalization process is performed based on a minimum value and a maximum value, and conversion is performed such that a lower elevation results in a higher evaluation, a higher population density results in a higher evaluation, a higher traffic flow results in a higher evaluation, a lower disaster risk results in a higher evaluation, a more stable power supply results in a higher evaluation, and an absence of existing infrastructure results in a higher evaluation, thereby arranging data of different units and scales into a state where they can be compared on the same standard. Specifically, the system applies a feature scaling algorithm to a multidimensional feature vector associated with each voxel. The system analyzes a distribution of each feature and removes or clips an outlier using a statistical method. For example, the system applies min-max scaling to elevation data to linearly convert a value into a range from zero to one. The system performs standardization after applying logarithmic transformation to data following a log-normal distribution, such as population density data and traffic flow data. The system executes a process of inverting a value of a specific dimension in order to unify evaluation directions. For example, for an index value of a disaster risk, the system subtracts the index value from one, thereby converting the value such that a lower risk results in a larger value. The system converts categorical data into a continuous dense vector using an embedding layer. Through these preprocessing steps, the system generates a normalized feature tensor in which all dimensions have the same scale and evaluation direction. By this normalization process, the system dramatically improves a convergence speed in a gradient descent method of a machine learning model. The system prevents overestimation of a specific variable due to a difference in scale and stabilizes inference accuracy of the model. The system ensures accuracy of distance calculation in a high-dimensional space. The system brings about technical effects of improving data quality and optimizing calculation efficiency in use cases such as an environmental monitoring system that integrally analyzes heterogeneous mixed data obtained from a plurality of different sensor networks and a field evaluation system in smart agriculture.
Step 3: Installation Candidate Site Scoring and Extraction by Generative AI The normalized various types of data are input to the generative AI processing unit, a total score is calculated while dynamically adjusting weighting for each installation purpose or type of urban infrastructure, and a point with a high score or a point exceeding a predetermined threshold is extracted as an installation candidate site. The generative AI also incorporates past installation record data, feedback from on-site personnel, a future population growth prediction, disaster risk information, installation cost information, operation cost data, a maintenance history, the number of complaints from users, a resident questionnaire result, user feedback data, and the like as learning data, and continuously improves extraction accuracy of the installation candidate site. Specific examples of a prompt sentence to be read by the generative AI include “Integrally analyze elevation data, population density data, traffic flow data, disaster risk data, power grid stability data, and existing infrastructure presence/absence data included in the following city map, and extract the top 10 points optimal for installing a disaster prevention base. Output coordinates, an elevation, a population density, a traffic flow, a disaster risk, a power grid stability, an existing infrastructure presence/absence, and a total score for each point.” and “Extract an optimal candidate site for installing a shared mobility port with an emphasis on a traffic flow and a population density.” Specifically, the generative AI processing unit is implemented as a deep learning model including a transformer-based encoder-decoder architecture. The generative AI processing unit receives a normalized feature tensor and an embedding vector of a natural language prompt sentence combined as an input. The generative AI processing unit receives, for example, a prompt vector instructing to extract the top 10 points optimal for installing a disaster prevention base and a 256-dimensional feature tensor of each voxel as inputs. The generative AI processing unit calculates a relevance between an intention of the prompt and each feature using a self-attention mechanism to generate a dynamic attention weight. The generative AI processing unit executes purpose-specific weighting by multiplying the feature tensor by the attention weight. The generative AI processing unit outputs an installation suitability score in a range from zero to one for each voxel via a multilayer perceptron. The generative AI processing unit generates, as an output, structured JSON data or list-format data such as coordinates X, Y, and Z, a total score of 0.95, and main factors being a low disaster risk and a high population density. The system sorts the output scores in descending order and extracts the top N voxels as installation candidate sites. The system transfers coordinate data of the extracted candidate sites to a subsequent visualization module. The generative AI processing unit continuously updates weight parameters of the model using contrastive learning in which past successful installation cases are positive examples and failure cases are negative examples. By this dynamic attention mechanism, the system dramatically improves versatility and adaptability to various installation purposes compared to a conventional method using a fixed weighting coefficient. The system realizes data-driven decision-making that does not rely on human intuition. The system provides technical effects of maximizing return on investment and shortening a plan formulation time in use cases such as optimization of electric vehicle charging station arrangement and sales maximization arrangement of vending machines.
Step 4: Installation Candidate Site Detailed Data Generation and Organization For the extracted installation candidate sites, detailed data such as coordinates, an elevation, a population density, a traffic flow, a disaster risk, a power grid stability, an existing infrastructure presence/absence, a total score, surrounding environment information, cost information, a future population growth prediction, consistency with an urban development plan, a relationship with an evacuation route during a disaster, land owner information, legal regulation/ordinance information, a maintenance cost, resident satisfaction, and a user convenience improvement effect of each point are organized and transmitted to the visualization unit. Specifically, the system issues a query to a distributed database using a spatial index of each extracted installation candidate site as a key. By this query, the system acquires all raw data and prediction data related to each candidate site. The system integrates the acquired data and constructs a hierarchized data object for each candidate site. For example, the system inputs future population growth prediction data to an LSTM network, which is a time-series prediction model, to generate a population transition vector for the next 10 years. The system analyzes a relationship with an evacuation route during a disaster using a graph neural network to calculate a shortest route length from the point to a nearest evacuation shelter and a safety score of the route. The system adds these advanced analysis results as properties of the data object. The system inputs text data such as cost information and legal regulation information to a natural language generation model to generate a summary text that is easy for humans to understand. The system also stores this summary text in the data object. The system serializes the completed data object into a JSON format. The system transmits the serialized data to the visualization unit via a high-speed RESTful API. By this data integration and organization process, the system aggregates a vast amount of distributed information into a single structured format. Thereby, the system reduces a load of a rendering process in the visualization unit and minimizes a delay in data reading. The system brings about technical effects of reducing an information collection cost and realizing multifaceted evaluation in use cases such as a site evaluation system in real estate development and a store opening plan support system for a large-scale commercial facility.
Step 5: Three-Dimensional Visualization by AR/VR and On-Site Comparison and Examination Using the detailed data of the installation candidate sites, the visualization unit superimposes and displays positions, recommendation degrees, various scores, and detailed attributes of the installation candidate sites in an AR or VR three-dimensional space, and realizes pin displaying and pop-up displaying on a camera image of a tablet terminal, multilayered visualization on a three-dimensional model of an entire city using VR goggles, simultaneous comparison displaying of a plurality of candidate sites, and the like, so that on-site personnel and a city planner can intuitively and multifacetedly compare and examine them. Specifically, the visualization unit executes an advanced graphics pipeline utilizing a GPU of an edge device. The visualization unit deserializes the received detailed data in the JSON format and maps it to properties of a virtual object in the three-dimensional space. In an AR mode, the visualization unit applies a SLAM algorithm to a real-time video frame acquired from a camera of a terminal to simultaneously perform self-position estimation and environment mapping. Using the estimated camera posture matrix, the visualization unit superimposes and draws a virtual pin object and an information panel at correct three-dimensional coordinates in a real space. In a VR mode, the visualization unit loads three-dimensional point cloud data and a polygon model of the entire city into a memory and renders a scene from a viewpoint of a virtual camera. The visualization unit dynamically changes a light emission intensity of the virtual object and a density of a particle effect according to a height of the total score. The visualization unit calculates a user's line-of-sight vector and a raycast of a controller to perform intersection determination with the virtual object. When an intersection is detected, the visualization unit draws a detailed attribute vector of the candidate site as a pop-up window. By this three-dimensional visualization process, the system clarifies a spatial context and a positional relationship with a surrounding environment, which are difficult to grasp with a two-dimensional map or spreadsheet software. The system expands human spatial cognitive ability and promotes understanding of complex multidimensional data. The system provides technical effects of early discovery of a design error and acceleration of consensus building among stakeholders in use cases such as a piping plan simulation of an underground buried object and a landscape simulation.
Step 6: On-Site Information Collection and Feedback Reflection On-site personnel input a new obstacle, a population fluctuation, event holding information, a request from a resident, observation data on site, an on-site photograph, a user's action log, and the like from a terminal on site, and these pieces of information are reflected in the generative AI on the server side in real time to immediately update evaluation and an extraction result of the installation candidate site. Specific examples of a prompt sentence to be read by the generative AI include “Recalculate evaluation of an installation candidate site in consideration of additional information acquired on site. Reflect a new obstacle, a population fluctuation, event holding information, and a resident request, and re-extract an optimal installation candidate site.” Specifically, the system receives an input of unstructured data through a client application running on an edge terminal. The system inputs the input on-site photograph to a convolutional neural network and outputs a bounding box and a class label of an object in an image. The system acquires an inference result such as a class temporary tent, a reliability of 0.92, and coordinates X and Y, for example. The system inputs the input text comment to a natural language processing model and executes keyword extraction and sentiment analysis. The system converts these analysis results into a structured feedback vector. The system combines this feedback vector and a prompt vector instructing to recalculate the evaluation of the installation candidate site in consideration of the additional information acquired on site. The system transmits this combined tensor to the generative AI processing unit on the server side. The generative AI processing unit receives this new tensor as an input and dynamically updates an existing feature tensor. The generative AI processing unit re-executes a forward pass using the updated feature tensor to recalculate an installation suitability score of each voxel. The generative AI processing unit outputs a new top N candidate site list based on the recalculated score. The system completes this series of processes within a few seconds and asynchronously updates a screen display of the terminal. By this online learning and dynamic inference mechanism, the system eliminates a delay caused by batch processing. The system exhibits extremely high adaptability to dynamic environmental changes on site. The system brings about technical effects of immediate responsiveness to a situation change and refinement of a plan in use cases such as temporary infrastructure arrangement during disaster recovery and security guard arrangement optimization during a large-scale event.
Step 7: Final Determination of Installation Plan and Continuous Optimization On-site personnel or an administrator finally determines an optimal installation candidate site based on a result of comparison and examination in the AR/VR visualization unit and on-site information, and continuously collects an operation record, resident feedback, a maintenance cost, a user convenience improvement effect, and the like even after installation, and the generative AI continues to learn these operation records, whereby a future installation plan, re-evaluation of existing infrastructure, additional installation, a removal proposal, an operation improvement proposal, and the like can be automatically performed. Specifically, the system receives coordinate data and a confirmation flag of the finally determined installation point via a user interface unit. The system stores this confirmed data in a database as a correct label. After the infrastructure is installed, the system continuously collects time-series telemetry data such as an operation rate, power consumption, and a failure history from an IoT sensor group installed at the target point. The system aggregates this telemetry data in a certain time window to generate an operation record vector. The system calculates an error between this operation record vector and a predicted score before installation using a mean squared error function. Using this error signal, the system fine-tunes weight parameters of a neural network of the generative AI processing unit by backpropagation. By this reinforcement learning-like approach, the system autonomously improves prediction accuracy of the model. The system periodically executes a re-evaluation batch process for all city grids. When an operation record vector of existing infrastructure falls below a predetermined threshold, the system outputs an alert signal proposing removal or relocation of the infrastructure. The system outputs recommended coordinates for additional installation for an area where a demand prediction vector exceeds a supply capacity. By this continuous learning loop, the system realizes optimization over an entire life cycle of the infrastructure. The system evolves a conventional maintenance plan depending on human rules of thumb into a data-driven predictive maintenance system. The system provides technical effects of dramatic reduction in operation costs and continuous improvement in service quality in use cases such as water leakage detection and renewal planning of a water pipe network and route network reorganization of public transportation.

### Specific Use Case

For example, when the present invention is applied to a new establishment plan of a disaster prevention base in a city, the urban infrastructure data acquisition unit divides an entire city into 25-meter square grids, acquires elevation data for each grid from a geographic information system, a satellite image, and drone aerial photography data, and uses it for evaluating a flood risk and a land subsidence risk. Population density data is acquired from a census, location information of mobile terminals, a traffic flow sensor, commercial facility visitor count data, event organizer visitor count data, Wi-Fi access point connection count data, and the like, and population fluctuations and human flow peaks for each of weekdays/holidays, day/night, event holding times, and seasons are grasped. Traffic flow data is acquired from a road sensor, the number of passing vehicles at an intersection, GPS data of vehicles, the number of passengers of public transportation, the number of users of a bus stop or a station, usage data of a shared mobility service, road congestion degree data, a traffic accident occurrence history, and the like, and a place with a large flow of people and vehicles, a place where traffic congestion frequently occurs, and a place with a high traffic accident risk, such as a main road, an intersection, around a station, and around a commercial facility, are specified. Disaster risk data is acquired from a past disaster history, a hazard map, weather data, ground information, soil classification data, flood and sediment disaster risk data, earthquake motion prediction data, tsunami inundation assumption area data, a fire occurrence history, evacuation shelter location information, emergency vehicle passage route information, and the like, and risks of an earthquake, a flood, a sediment disaster, a fire, a tsunami, a storm surge, a windstorm, a lightning strike, and the like are multifacetedly evaluated. Power grid stability data is acquired from supply grid information of a power company, a past power outage history, a renewable energy introduction status, presence/absence of a distributed power source, supply stability at a peak of power demand, location information of a transmission line/substation, an aging status of power infrastructure, and the like, and a place where stable power supply can be expected, a place with a low power outage risk, and a place where local production for local consumption of renewable energy is possible are evaluated. Existing infrastructure presence/absence data is acquired from an urban infrastructure management ledger, field survey data, field image analysis by a drone or an autonomous driving vehicle, operation status data from a sensor network, report data from a resident, and the like, and whether or not the same type of infrastructure has already been installed, presence/absence of aging or failure, a usage rate, a maintenance status, and the like are determined. Furthermore, land use classification data, ground strength data, event holding information, public transportation usage data, urban development plan data, legal regulation/ordinance information, land owner information, installation cost data, maintenance cost data, a resident questionnaire result, user feedback data, usage record data after operation, and the like are also acquired and utilized for multifaceted optimization of urban infrastructure arrangement. Specifically, the urban infrastructure data acquisition unit issues asynchronous HTTP requests to a plurality of external API endpoints to collect petabyte-class raw data in parallel. The urban infrastructure data acquisition unit stores the acquired raw data in a data lake on a distributed file system. The urban infrastructure data acquisition unit executes an ETL process on the raw data in the data lake using a distributed processing framework such as Apache Spark. For example, the urban infrastructure data acquisition unit extracts a stay point from a location information log of a mobile terminal using a DBSCAN clustering algorithm to generate a population density tensor for each time zone. The urban infrastructure data acquisition unit generates a traffic congestion occurrence probability map from GPS trajectory data of vehicles using a hidden Markov model. The urban infrastructure data acquisition unit executes a fluid dynamics simulation from past weather data and terrain data to calculate an inundation depth prediction vector of each grid. The urban infrastructure data acquisition unit combines these highly processed data using a 25-meter square spatial index as a key to construct, for example, a 1024-dimensional ultra-high-dimensional feature vector for each grid. In this way, the system generates a dataset including not just static statistical data but dynamic and predictive features. By this data integration process, the system eliminates siloing of heterogeneous mixed data and provides a unified format that can be directly interpreted by a machine learning model. The system significantly reduces calculation resources and time required for data preprocessing. The system brings about a technical effect of supporting objective and rapid decision-making based on data in use cases such as construction of an integrated command center in a smart city and dynamic formulation of a wide-area evacuation plan.

These various types of data are input to the generative AI processing unit, and a total score is calculated by dynamically adjusting weighting such that a lower elevation results in a higher evaluation, a higher population density results in a higher evaluation, a higher traffic flow results in a higher evaluation, a lower disaster risk results in a higher evaluation, a more stable power supply results in a higher evaluation, and an absence of existing infrastructure results in a higher evaluation, using a prompt sentence such as, for example, “Integrally analyze elevation data, population density data, traffic flow data, disaster risk data, power grid stability data, and existing infrastructure presence/absence data included in the following city map, and extract the top 10 points optimal for installing a disaster prevention base. Output coordinates, an elevation, a population density, a traffic flow, a disaster risk, a power grid stability, an existing infrastructure presence/absence, and a total score for each point.” The generative AI also incorporates past installation record data, feedback from on-site personnel, a future population growth prediction, disaster risk information, installation cost information, operation cost data, a maintenance history, the number of complaints from users, a resident questionnaire result, user feedback data, and the like as learning data, and continuously improves extraction accuracy of the installation candidate site. Specifically, the generative AI processing unit adopts a hybrid architecture integrating a large language model and a graph neural network. The generative AI processing unit divides the input prompt sentence into a token sequence by a tokenizer and converts it into a high-dimensional prompt vector via an embedding layer. The generative AI processing unit constructs an urban space graph in which a 1024-dimensional feature vector of each grid is a node and adjacent grids are connected by an edge. The generative AI processing unit applies a graph convolution operation to this urban space graph to generate a node embedding vector considering a spatial dependency relationship. The generative AI processing unit executes a cross-attention mechanism using the prompt vector as a query and the node embedding vector as a key and a value. By this cross-attention, the generative AI processing unit dynamically allocates a high attention weight to a feature that best matches an instruction content of the prompt. The generative AI processing unit inputs this weighted vector to a fully connected layer and outputs a total score of each grid as a probability value from zero to one by a sigmoid function. The generative AI processing unit generates, as an output result, a structured JSON object such as coordinates X and Y, a total score of 0.98, and main factors being a high power grid stability and a low disaster risk, for example. The generative AI processing unit calculates a cross-entropy error using coordinates of past successful cases as positive labels and updates weights of the model by a gradient descent method. By this hybrid model, the system realizes advanced inference that simultaneously understands a spatial context and a complex language instruction. The system flexibly adapts to various installation conditions that cannot be handled by a fixed algorithm. The system provides technical effects of a dramatic improvement in inference accuracy and automation of plan formulation in use cases such as optimization of an ambulance standby location and an arrangement plan of a drone port.

The installation candidate site selection unit extracts the top 10 points in score as installation candidate sites based on the total score calculated by the generative AI processing unit, and organizes detailed data such as coordinates, an elevation, a population density, a traffic flow, a disaster risk, a power grid stability, an existing infrastructure presence/absence, a total score, surrounding environment information, cost information, a future population growth prediction, consistency with an urban development plan, a relationship with an evacuation route during a disaster, land owner information, legal regulation/ordinance information, a maintenance cost, resident satisfaction, and a user convenience improvement effect of each point. Using these detailed data, the visualization unit superimposes and displays positions, recommendation degrees, various scores, and detailed attributes of the installation candidate sites in an AR or VR three-dimensional space, and realizes pin displaying and pop-up displaying on a camera image of a tablet terminal, multilayered visualization on a three-dimensional model of an entire city using VR goggles, simultaneous comparison displaying of a plurality of candidate sites, and the like, so that on-site personnel and a city planner can intuitively and multifacetedly compare and examine them. Specifically, the installation candidate site selection unit applies a quicksort algorithm to a score array of all grids output from the generative AI processing unit to sort them in descending order. The installation candidate site selection unit extracts the top 10 indices from this sort result. Using this index, the installation candidate site selection unit fetches a detailed attribute vector of each point from a distributed database. The installation candidate site selection unit serializes this attribute vector into a JSON-format payload and transmits it to the visualization unit. The visualization unit parses the received payload and inputs it to a three-dimensional rendering engine. The visualization unit generates a virtual anchor point corresponding to coordinates of each candidate site on a three-dimensional base map of the city. The visualization unit arranges a cylindrical 3D virtual object having a height corresponding to the total score at this anchor point. The visualization unit generates each index such as a disaster risk and a population density as a polygon of a radar chart and floatingly displays it above the virtual object. In a VR environment, the visualization unit acquires user's head tracking data and updates a rendering matrix of a viewpoint camera at a rate of 60 frames per second or more. When the user points to a specific candidate site with a controller, the visualization unit performs collision determination by raycast and dynamically instantiates an information panel describing detailed text data. By this advanced three-dimensional graphics processing, the system converts a vast amount of numerical data into a visually intuitive format. The system supports a human cognitive process and facilitates understanding of a complex trade-off relationship. The system brings about technical effects of streamlining information sharing and accelerating decision-making in use cases such as a resident briefing session and an infrastructure investment meeting in an urban redevelopment project.

On-site personnel input a new obstacle, a population fluctuation, event holding information, a request from a resident, observation data at a site, a site photograph, a user behavior log, and the like from a terminal at the site, reflect these pieces of information in the generative AI on the server side in real time, and immediately update an evaluation and an extraction result of the installation candidate site using a prompt sentence such as, for example, “Recalculate the evaluation of the installation candidate site in consideration of the additional information acquired at the site. Re-extract the optimal installation candidate site reflecting the new obstacle, the population fluctuation, the event holding information, and the resident request.” Finally, the on-site personnel or an administrator determines the optimal installation candidate site based on a result of comparative examination by the AR/VR visualization unit and the site information, continuously collects an operation record, resident feedback, a maintenance and management cost, a user convenience improvement effect, and the like even after installation, and the generative AI continues to learn these operation records, whereby a future installation plan, re-evaluation of existing infrastructure, additional installation, a removal proposal, an operation improvement proposal, and the like can be automatically performed. Specifically, the present system transmits new data acquired from a sensor group of an edge terminal to the server via a stream processing pipeline. The present system inputs, for example, an image captured at the site to a convolutional neural network, and outputs a class label of an unregistered building under construction and a three-dimensional bounding box. The present system adds coordinate data of this new obstacle to an attribute vector of a corresponding node of an urban space graph. The present system inputs the updated urban space graph and a prompt vector for recalculation to the generative AI processing unit. The generative AI processing unit executes a graph convolution operation and a cross-attention mechanism again, and recalculates an installation suitability score of each node in milliseconds. The present system asynchronously updates a three-dimensional display of the visualization unit based on this recalculation result. The present system commits coordinates and a feature vector of the point to a learning database as correct answer data when the administrator selects a specific candidate site on the terminal and presses a confirmation button. The present system inputs time-series data such as an operating rate and power consumption collected from an IoT sensor after infrastructure operation to a recurrent neural network, and calculates an operation performance score. The present system applies a reinforcement learning algorithm using this performance score as a reward signal, and updates a policy network of the generative AI processing unit. The present system autonomously improves inference accuracy of a model over time by this closed-loop feedback system. The present system exhibits robust adaptability to secular changes in an environment and unexpected disturbances. The present system provides extremely important technical effects of minimizing an operation cost and improving resilience of the entire system in use cases such as optimal arrangement of storage batteries in a smart grid and base station life cycle management of a next-generation communication network.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

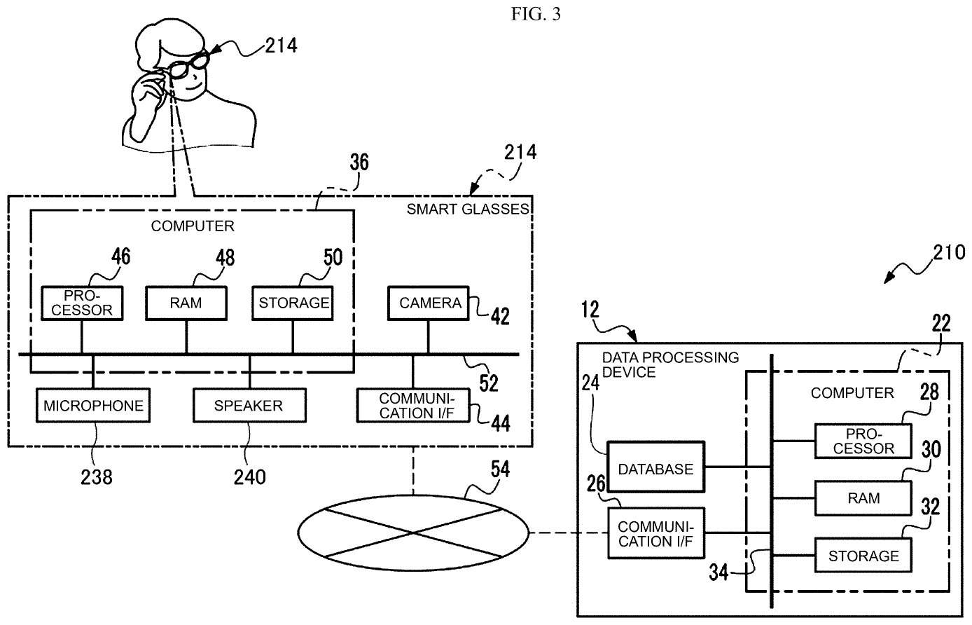

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

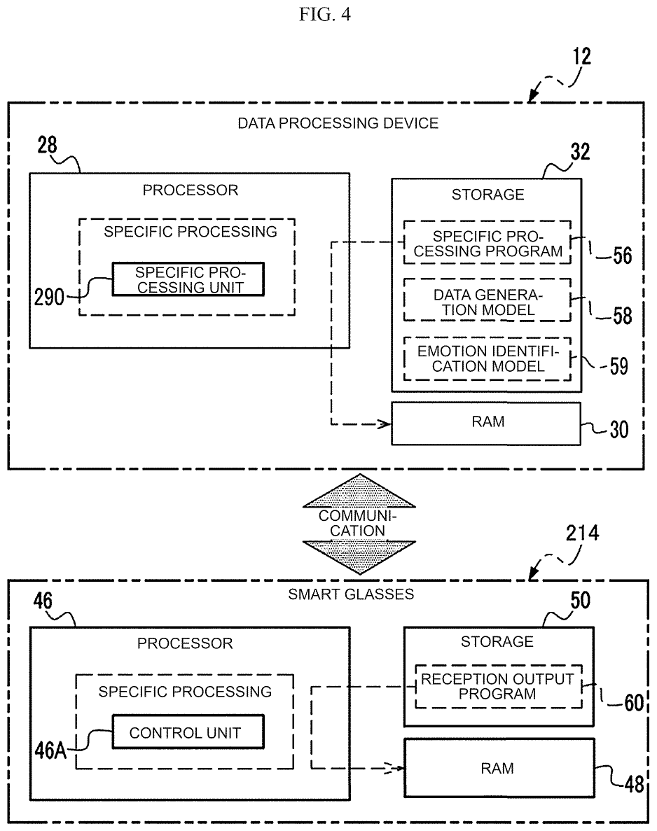

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

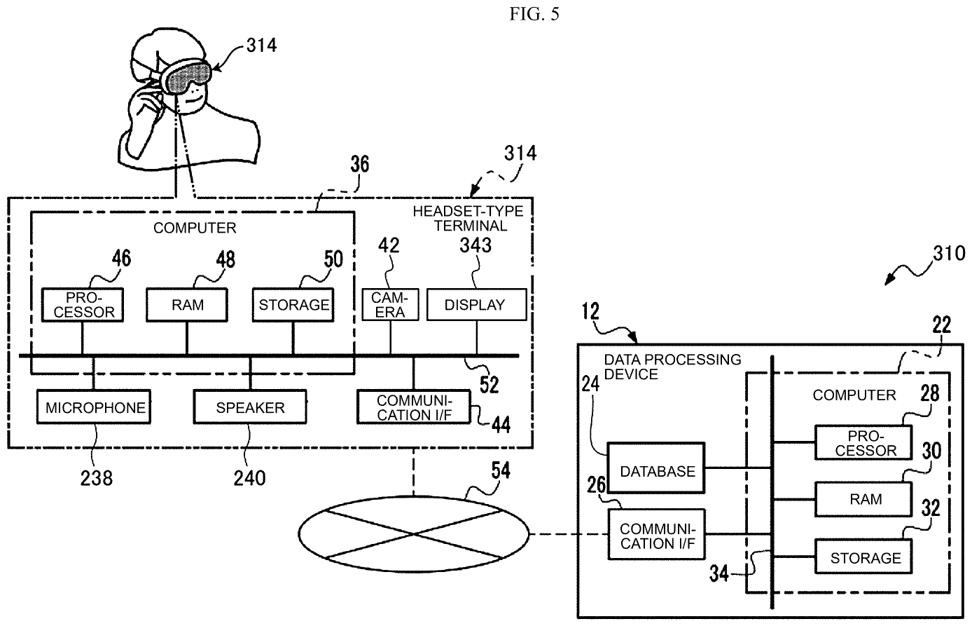

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

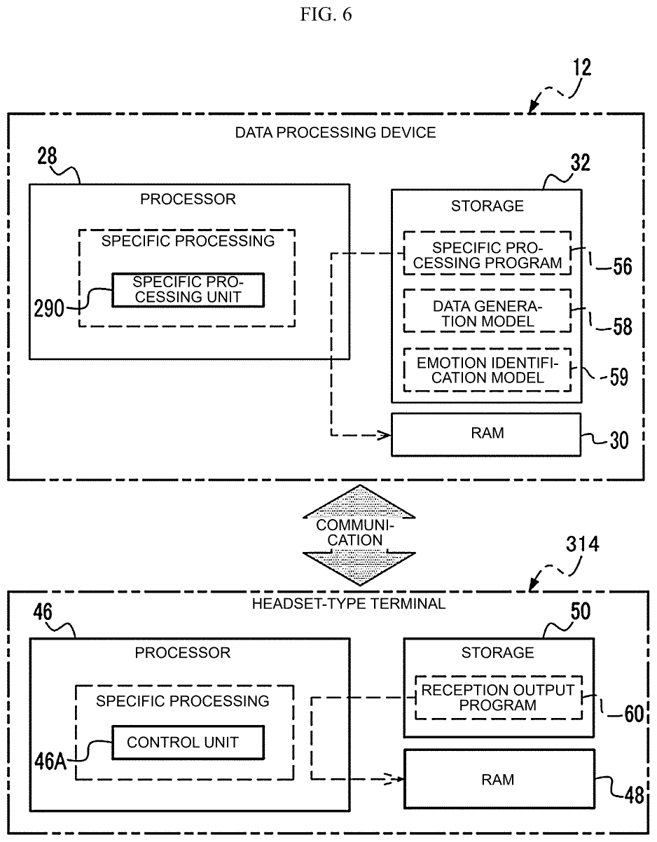

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

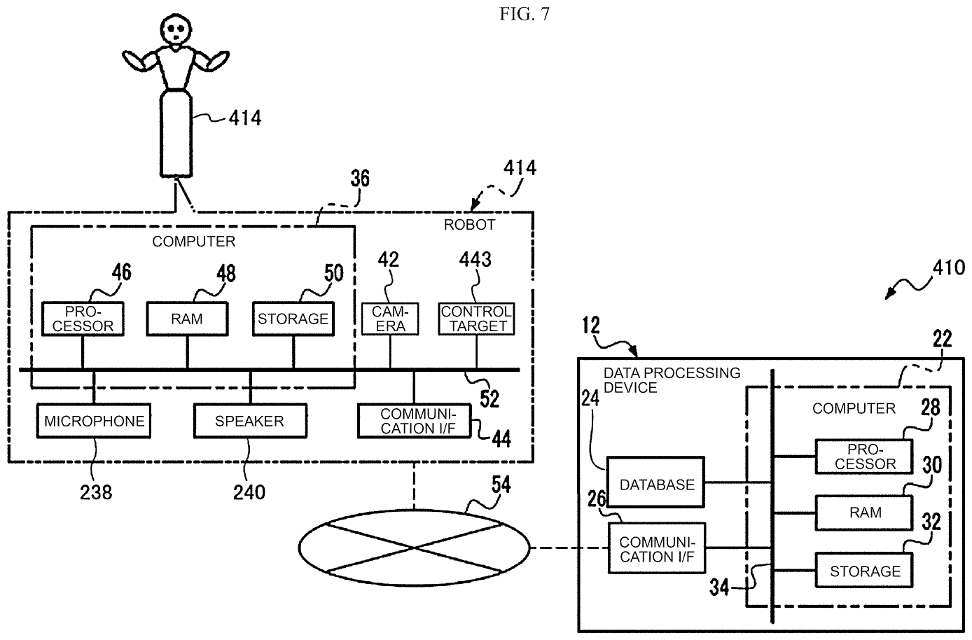

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

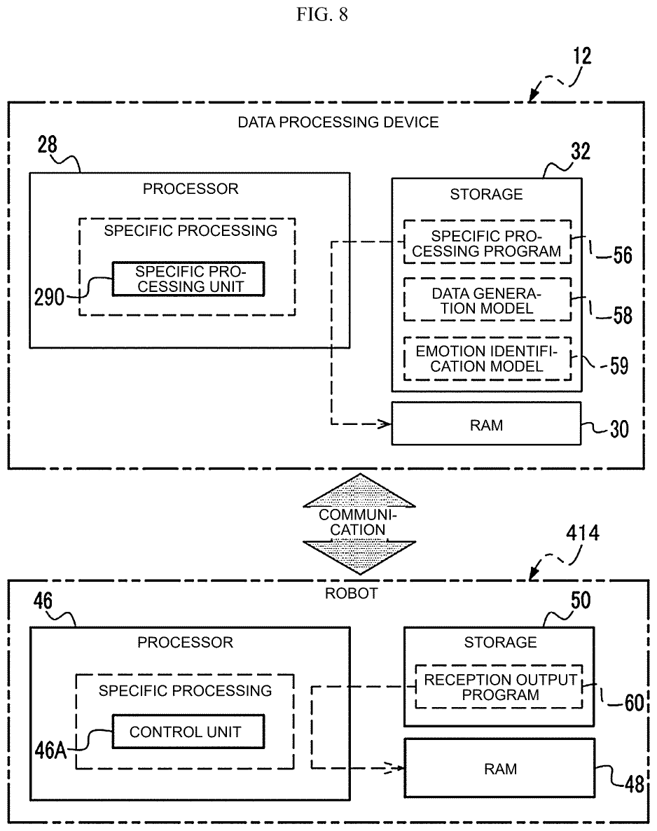

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

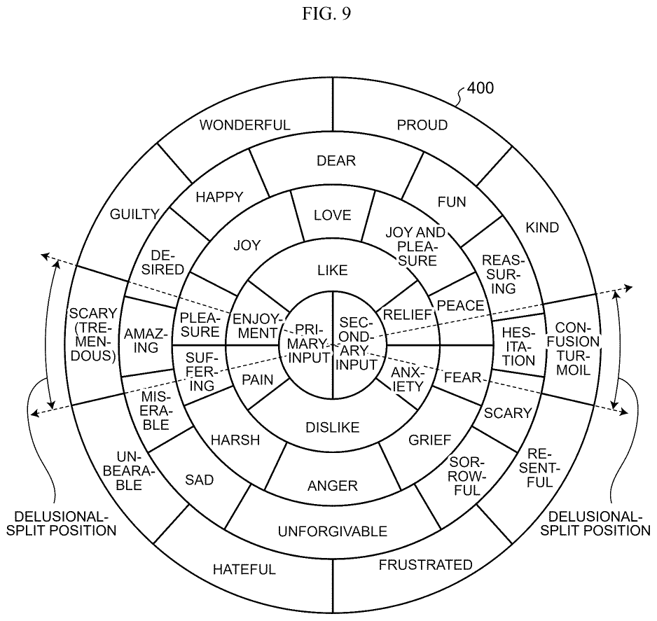

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

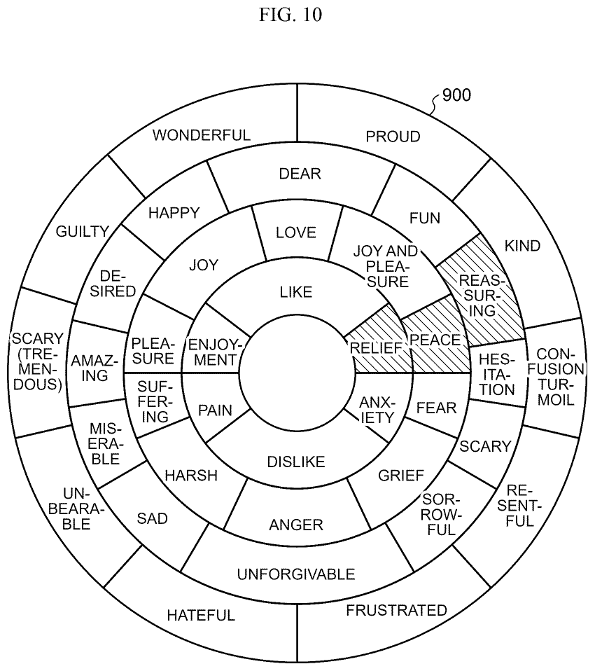

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### (Supplementary Note 1)

A system comprising an urban infrastructure data acquisition unit, a generative AI processing unit, an installation candidate site selection unit, and a visualization unit, wherein the urban infrastructure data acquisition unit is configured to collect various types of information such as elevation data, population density data, traffic flow data, disaster risk data, power grid stability data, and existing infrastructure presence/absence data for each grid in a city from a geographic information system, a satellite image, drone aerial photography, a census, a traffic sensor, a weather database, an urban infrastructure management ledger, or the like, the generative AI processing unit is configured to normalize the acquired various types of data, dynamically adjust weighting for each installation purpose or type of urban infrastructure, calculate a total score such that a lower elevation results in a higher evaluation, a higher population density results in a higher evaluation, a higher traffic flow results in a higher evaluation, a lower disaster risk results in a higher evaluation, a more stable power supply results in a higher evaluation, and an absence of existing infrastructure results in a higher evaluation, and further execute a process using generative AI that continuously improves extraction accuracy of an installation candidate site by incorporating past installation record data, feedback from on-site personnel, a future population growth prediction, disaster risk information, installation cost information, and the like as learning data, the installation candidate site selection unit is configured to extract a point with a high score or a point exceeding a predetermined threshold as the installation candidate site based on the total score calculated by the generative AI processing unit, and organize detailed data such as coordinates, an elevation, a population density, a traffic flow, a disaster risk, a power grid stability, an existing infrastructure presence/absence, a total score, surrounding environment information, a disaster risk, and cost information for each candidate site, and the visualization unit is configured to intuitively display information on the extracted installation candidate site in an AR or VR three-dimensional space so that on-site personnel or a city planner can compare and examine the information on-site or in a virtual space.

### (Supplementary Note 2)

The system according to Supplementary Note 1, wherein the urban infrastructure data acquisition unit is configured to collect various types of data such as urban development plan data, land use classification data, ground strength data, soil classification data, flood and sediment disaster risk data, public transportation usage data, renewable energy introduction status, past disaster history, power outage history, event holding information, and field survey data in addition to an elevation, a population density, a traffic flow, a disaster risk, a power grid stability, and an existing infrastructure presence/absence for each grid obtained by subdividing an entire city, and input these to the generative AI processing unit.

### (Supplementary Note 3)

The system according to Supplementary Note 1, wherein the visualization unit has a function of stereoscopically displaying detailed information such as three-dimensional coordinates, an elevation, a population density, a traffic flow, a disaster risk, a power grid stability, an existing infrastructure presence/absence, a total score, surrounding environment information, a disaster risk, and cost information of each candidate site for a plurality of installation candidate sites extracted by the installation candidate site selection unit in a three-dimensional space so that a user can intuitively compare and examine the detailed information, and further pop-up displaying the detailed information of an arbitrary candidate site when the user selects the arbitrary candidate site, and wherein a series of these processes is realized using generative AI.

What is claimed is:

1. A system comprising:
circuitry configured to:
receive, via a communication interface coupled to a packet-switched network, terrain attribute data, population density data, and radio wave propagation characteristic data for a plurality of geographic grid cells, and store the received data in a storage device;
construct a hierarchical grid data structure by applying a space division algorithm that assigns unique identifiers to grid cells and subdivides cells with high data density at finer resolution, and manage attribute data for each grid cell in a distributed database;
apply a generative neural network model comprising a graph neural network inference engine to the hierarchical grid data structure by constructing a graph in which each grid cell is a node and adjacency relationships are edges, executing a message passing algorithm to propagate feature information between adjacent nodes, and generating a latent representation vector and a suitability score for each grid cell node;
cluster grid cell nodes by suitability score to identify candidate installation area records, and generate a candidate site data record for each candidate installation area comprising geographic coordinate data, suitability score parameters, and coverage projection data; and
transmit the candidate site data records and three-dimensional spatial visualization data derived from the hierarchical grid data structure to terminal devices via the communication interface.

2. The system according to claim 1, wherein the circuitry is configured to acquire terrain attribute data from a geographic information system data service via the communication interface comprising elevation values and inclination values for each geographic coordinate, normalize the acquired terrain attribute data to a standardized numerical range, and store the normalized terrain attribute data as feature attributes in the hierarchical grid data structure.

3. The system according to claim 2, wherein the circuitry is configured to acquire population density data from a statistical data service via the communication interface, aggregate population density values to the resolution of each grid cell, weight the aggregated population density values by a population density weighting parameter, and incorporate the weighted population density values as node feature attributes in the graph.

4. The system according to claim 3, wherein the circuitry is configured to acquire radio wave propagation characteristic data comprising signal attenuation values and multi-path propagation coefficients from a simulation data service or measured data records via the communication interface, normalize the propagation characteristic values, and incorporate the normalized values as additional node feature attributes in the graph prior to message passing.

5. The system according to claim 1, wherein the circuitry is configured to apply the space division algorithm as a quadtree data structure, assign finer grid resolution to areas with higher data density or population density values, and apply the graph neural network to the resulting variable-resolution grid graph to model spatial continuity and network topology effects across the hierarchical grid structure.

6. The system according to claim 1, wherein the circuitry is configured to compute the suitability score for each grid cell node as a normalized scalar value by applying a weighted combination of the terrain attribute features, population density features, and radio wave propagation characteristic features extracted from the node latent representation vector, and output the suitability score as a value in a standardized numerical range.

7. The system according to claim 6, wherein the circuitry is configured to apply a clustering algorithm to grid cell nodes to identify contiguous high-suitability areas, compute cluster centroid coordinates as candidate installation position data, and rank candidate installation area records in descending order of aggregated cluster suitability score.

8. The system according to claim 1, wherein the circuitry is configured to generate three-dimensional spatial visualization data from the hierarchical grid data structure by mapping suitability scores to a three-dimensional rendering coordinate system, generate an augmented reality overlay data record comprising candidate site markers and coverage projection contours, and transmit the augmented reality overlay data record to terminal devices for rendering over camera image data.

9. The system according to claim 8, wherein the circuitry is configured to generate a virtual reality environment data record from the three-dimensional spatial visualization data comprising a three-dimensional scene model of the geographic area with candidate site markers and simulated coverage projection visualizations, and transmit the virtual reality environment data record to terminal devices supporting virtual reality display.

10. The system according to claim 1, wherein the circuitry is configured to receive updated terrain attribute data, population density data, or radio wave propagation characteristic data via the communication interface, update the corresponding node feature attributes in the hierarchical grid data structure, re-apply the graph neural network message passing algorithm, and regenerate suitability scores and candidate site data records.

11. The system according to claim 1, wherein the circuitry is configured to apply a coverage simulation model to each candidate installation area record by computing projected signal coverage area using the radio wave propagation characteristic data and the candidate site geographic coordinate data, and incorporate the coverage projection data as an attribute of the candidate site data record.

12. The system according to claim 11, wherein the circuitry is configured to compute an aggregate coverage optimization score for a set of candidate installation area records by applying the generative neural network model to evaluate combined coverage projections for the set, minimizing coverage overlap between candidate sites while maximizing total population density coverage.

13. The system according to claim 1, wherein the circuitry is configured to receive constraint parameter data from a terminal device via the communication interface comprising exclusion zone data and regulatory boundary data, filter the hierarchical grid data structure to exclude grid cell nodes within exclusion zones, and re-apply the graph neural network to the filtered graph to generate updated candidate site data records satisfying the constraint parameters.

14. The system according to claim 1, wherein the circuitry is configured to apply a natural language processing model to query text received from a terminal device to extract geographic constraint parameters and optimization objective parameters, incorporate the extracted parameters as conditioning inputs in the generative neural network model during candidate site data record generation, and generate a natural language explanation of the top-ranked candidate site data records.

15. The system according to claim 1, wherein the circuitry is configured to store all candidate site data records, suitability scores, and coverage projection data in an audit log data structure with timestamps, and generate a comparison report from historical candidate site data records to track changes in optimal installation site recommendations across data update cycles.

16. The system according to claim 1, wherein the circuitry is configured to update the generative neural network model by generating training pairs from historical candidate site data records and corresponding validated installation outcome records, and fine-tune the model to improve suitability score prediction accuracy for specific terrain and population density patterns.

17. The system according to claim 1, wherein the terrain attribute data comprises elevation and inclination values from geographic information system records, the population density data comprises aggregate population counts per grid cell, and the radio wave propagation characteristic data comprises signal attenuation values at each grid cell location.

18. A system comprising:
circuitry configured to:
receive, via a communication interface coupled to a packet-switched network, terrain attribute data, population density data, and radio wave propagation characteristic data for geographic grid cells;
construct a hierarchical grid data structure using a space division algorithm and apply a graph neural network to a grid graph with adjacency edges to propagate feature information and generate suitability scores for each grid cell node;
cluster nodes by suitability score to identify candidate installation area records, and generate coverage projection data using a coverage simulation model;
generate three-dimensional spatial visualization data, augmented reality overlay data records, and virtual reality environment data records from the hierarchical grid data structure and candidate site data; and
transmit candidate site data records and visualization data to terminal devices via the communication interface.

19. The system according to claim 18, wherein the circuitry is configured to
receive constraint parameter data comprising exclusion zone data and regulatory boundary data from terminal devices, filter the hierarchical grid data structure to exclude constrained nodes, and compute an aggregate coverage optimization score for candidate installation area record sets by applying the generative neural network model to minimize overlap while maximizing total population density coverage.

20. A method comprising:
receiving, via a communication interface coupled to a packet-switched network, terrain attribute data, population density data, and radio wave propagation characteristic data for a plurality of geographic grid cells, and storing the received data in a storage device;
constructing a hierarchical grid data structure using a space division algorithm, and applying a graph neural network to a grid graph with adjacency edges to execute message passing and generate suitability scores for each grid cell node;
clustering grid cell nodes to identify candidate installation area records comprising geographic coordinate data and suitability score parameters;
generating three-dimensional spatial visualization data and coverage projection data from the hierarchical grid data structure; and
transmitting the candidate site data records and visualization data to terminal devices via the communication interface.
